(19) United States
(12) Patent Application Publication
(10) Pub. No.: US 2026/0316469 A1
(43) Pub. Date: Oct. 15, 2026

(54) Ink Jet Textile Printing Recording Apparatus And Ink Jet Textile Printing Recording Method

(71) Applicant: SEIKO EPSON CORPORATION, Tokyo (JP)

(72) Inventors: Hideki OKADA, Shiojiri (JP); Tomonori AMARI, Shiojiri (JP); Shin KOMATSU, Matsumoto (JP); Takahiro MATSUZAKI, Shiojiri (JP)

(21) Appl. No.: 19/465,120

(22) Filed: Jan. 30, 2026

(30) Foreign Application Priority Data
Jan. 31, 2025 (JP) 2025-015699

(51) Int. Cl. B41J 29/17; B41J 2/21; B41J 3/407; B41J 11/00; B41J 11/04

(52) U.S. Cl. CPC B41J 29/17; B41J 2/2107; B41J 3/4078; B41J 11/007; B41J 11/04

(57) ABSTRACT

An ink jet textile printing recording apparatus includes an ink composition, an ink jet head that ejects the ink composition onto a fabric which is a recording medium, an endless belt that places and transports the fabric, a cleaning section that cleans the endless belt, and a cleaning liquid, in which the endless belt has a pressure sensitive adhesive layer on a surface thereof, the cleaning section has a cleaning tank that stores the cleaning liquid, and an abrading member that rubs the pressure sensitive adhesive layer in the cleaning tank, and the cleaning liquid contains water and a cleaning agent containing a polyoxyalkylene alkyl ether compound.

The present application is based on, and claims priority from JP Application Serial Number 2025-015699, filed Jan. 31, 2025, the disclosure of which is hereby incorporated by reference herein in its entirety.

### BACKGROUND

### 1. Technical Field

The present disclosure relates to an ink jet textile printing recording apparatus and an ink jet textile printing recording method.

### 2. Related Art

Attempts are made to apply an ink jet method not only to recording images on paper and the like but also to textile printing on fabrics, and various ink jet textile printing methods are studied. Further, various studies have also been conducted on ink jet printing recording apparatuses and recording methods applicable to textile printing on fabrics.

For example, JP-A-2021-143429 describes an ink jet textile printing recording apparatus including a cleaning section that cleans a belt for transporting a fabric. The cleaning liquid in the same document is described as being able to use water or a water-soluble solvent (such as an alcohol aqueous solution).

However, in the ink jet textile printing recording apparatus, a belt may be used as a mechanism for transporting the fabric. In this case, ink is ejected from an ink jet head and adheres to the fabric placed on the belt. Various innovations are devised for such belts. For example, a method is proposed in which glue (grounding material) is applied to the surface of the belt to form a pressure sensitive adhesive layer and transport the fabric by adhesive force.

When a pressure sensitive adhesive layer is formed at the belt surface, the adhesive force causes the fabric to adhere to the belt, thus increasing the stability of the fabric during transport. On the other hand, as the adhesive force on the surface of the pressure sensitive adhesive layer decreases, it is sometimes difficult to maintain stable fabric transport. It is found that this decrease in the adhesive force of the surface of the pressure sensitive adhesive layer is caused by lint or fluff separating from the fabric, colorants and fixing materials contained in ink that adhere through the fabric, and various functional materials that are fixed to the surface of the pressure sensitive adhesive layer. In addition, when the fabric transport becomes unstable, such as when the adhesive force on the surface of the pressure sensitive adhesive layer decreases, uneven density may occur during image formation. Therefore, it is required to continuously and stably keep the surface of the pressure sensitive adhesive layer clean and to maintain the adhesive force so that uneven density at the time of image formation is unlikely to occur.

### SUMMARY

According to an aspect of the present disclosure, there is provided an ink jet textile printing recording apparatus including an ink composition, an ink jet head that ejects the ink composition onto a fabric which is a recording medium, an endless belt that places and transports the fabric, a cleaning section that cleans the endless belt, and a cleaning liquid, in which the endless belt has a pressure sensitive adhesive layer on a surface thereof, the cleaning section includes a cleaning tank that stores the cleaning liquid, and an abrading member that rubs the pressure sensitive adhesive layer within the cleaning tank, and the cleaning liquid contains water and a cleaning agent containing a polyoxyalkylene alkyl ether compound.

According to an aspect of the present disclosure, there is provided an ink jet textile printing recording method including ejecting an ink composition from an ink jet head and causing the ink composition to adhere to a fabric which is a recording medium, placing and transporting the fabric on an endless belt, and cleaning the endless belt, in which the endless belt has a pressure sensitive adhesive layer on a surface thereof, a cleaning section includes a cleaning tank that stores a cleaning liquid, the cleaning section includes an abrading member that rubs the pressure sensitive adhesive layer within the cleaning tank, and the cleaning liquid contains water and a cleaning agent containing a polyoxyalkylene alkyl ether compound.

### BRIEF DESCRIPTION OF THE DRAWINGS

FIG. 1 is a schematic diagram illustrating an example of a recording apparatus including a cleaning mechanism according to an embodiment.

FIG. 2 is a table (Table 1) illustrating the composition and evaluation results of a cleaning liquid of an example.

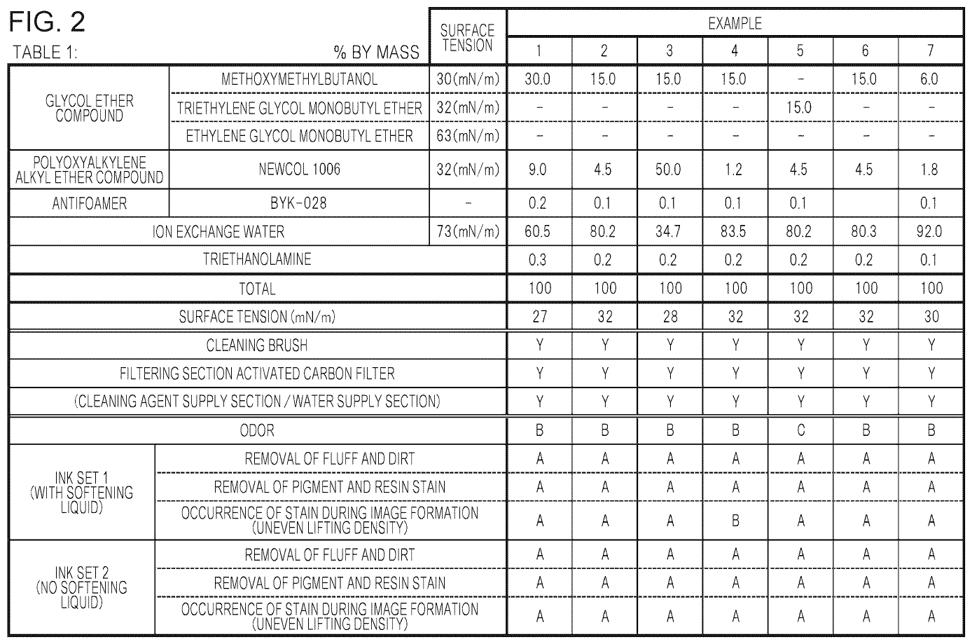

FIG. 3 is a table (Table 2) illustrating the composition and evaluation results of the cleaning liquid of the example.

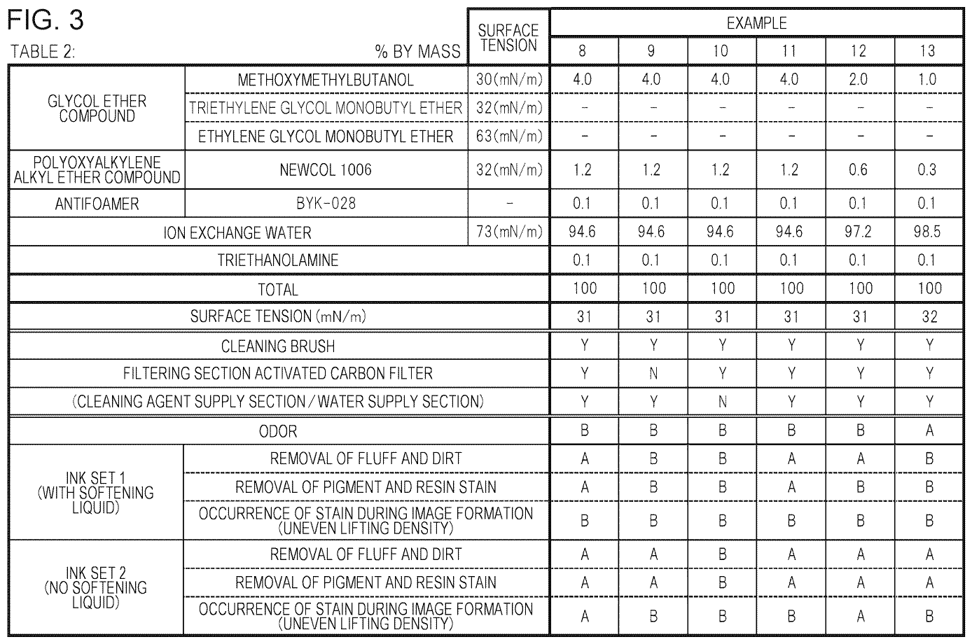

FIG. 4 is a table (Table 3) illustrating the composition and evaluation results of a cleaning liquid of a comparative example.

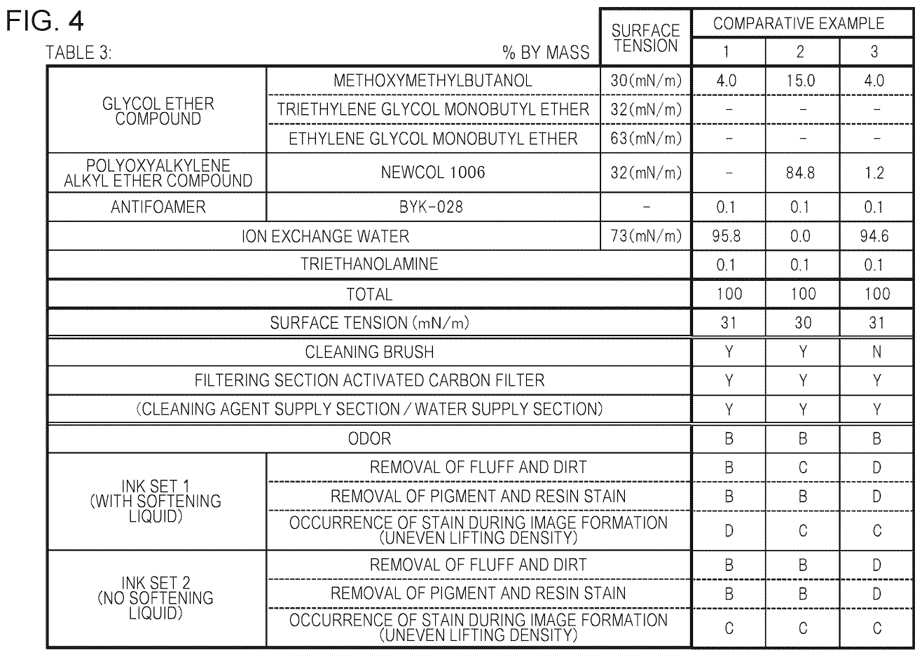

FIG. 5 is a table (Table 4) illustrating the composition of a first ink according to the example and the comparative example.

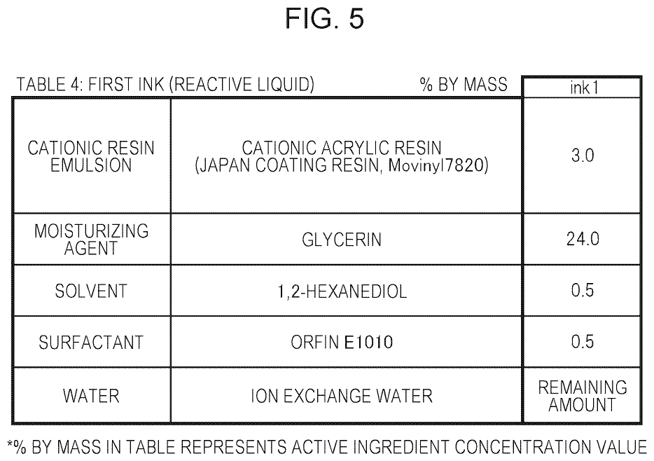

FIG. 6 is a table (Table 5) illustrating a composition of a second ink according to the example and the comparative example.

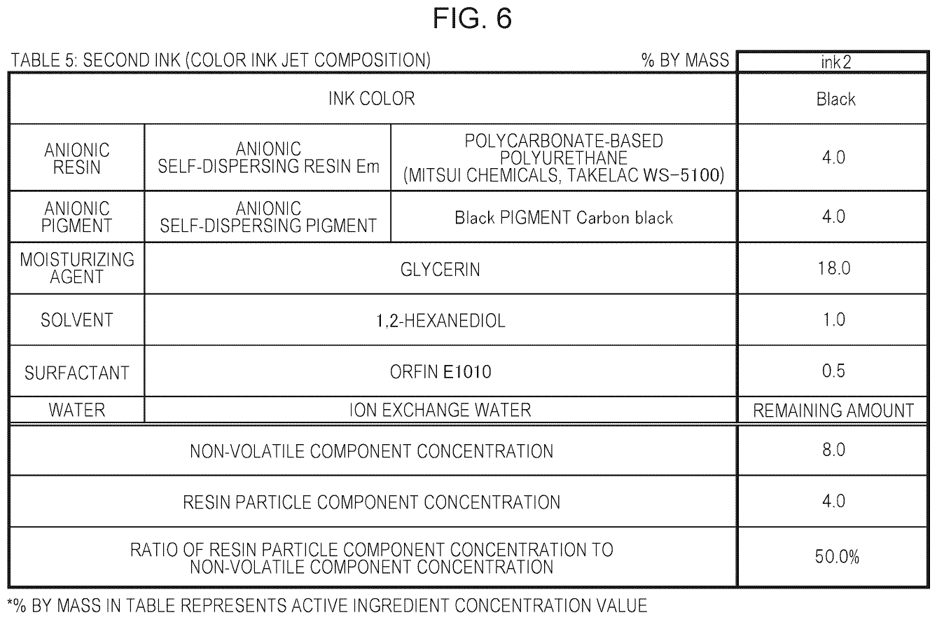

FIG. 7 is a table (Table 6) illustrating a composition of a third ink according to the example and the comparative example.

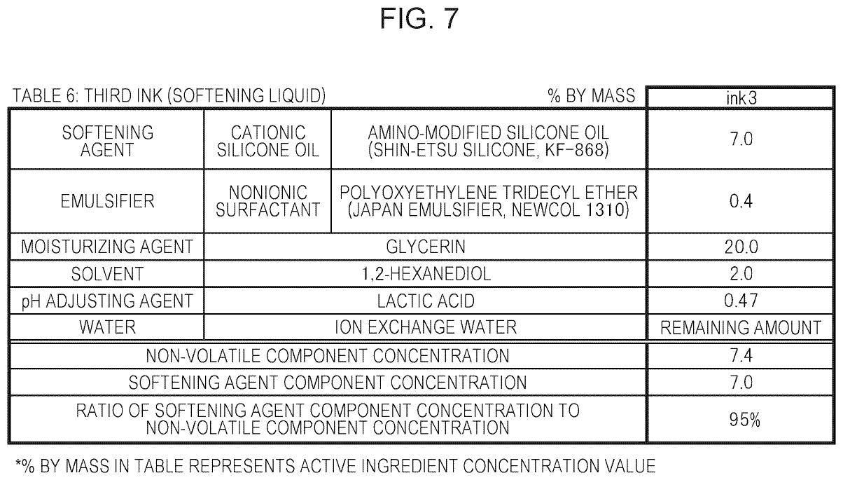

FIG. 8 is a table (Table 7) illustrating ink set combinations, printing conditions, and evaluation results according to the example and the comparative example.

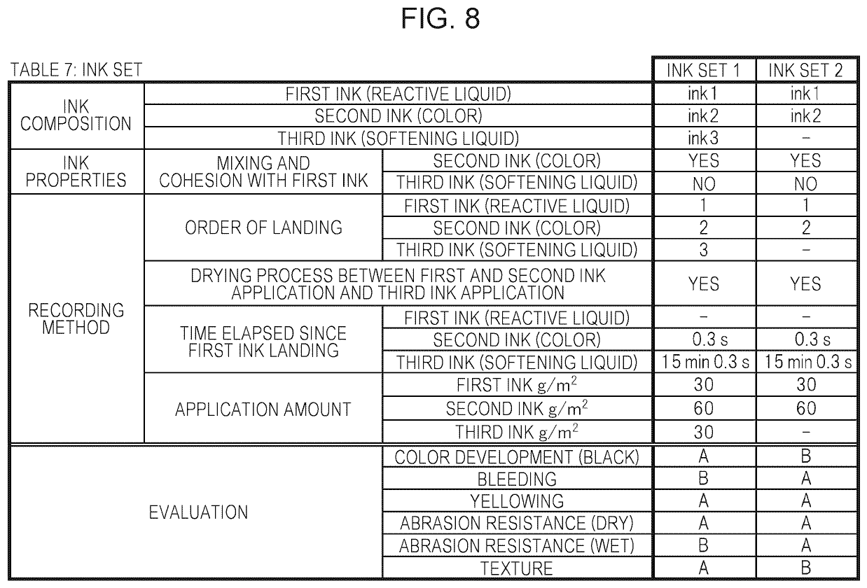

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing the gist of the present disclosure. It should be noted that not all of the configurations described below are essential configurations of the present disclosure.

In the present specification, a numerical value range represented using “to” means a range including numerical values shown before and after “to” as a lower limit value and an upper limit value.

In the present specification, the “ink jet method” refers to a droplet ejecting method using an ink jet method.

In the present specification, the term “white” when referring to the white pigment, the white ink, and the like does not refer only to perfect white, but also includes slightly colored colors with chromatic colors, achromatic colors, and glossy colors, within a range which is visible as white. For example, in CIELAB, L* is preferably 80 or more, and more preferably L* is 85 or more.

### 1. Ink Jet Textile Printing Recording Apparatus

According to the present embodiment, there is provided an ink jet textile printing recording apparatus including an ink composition, an ink jet head that ejects the ink composition onto a fabric which is a recording medium, an endless belt that places and transports the fabric, a cleaning section that cleans the endless belt, and a cleaning liquid.

### 1.1. Ink Composition

The ink composition provided in the ink jet textile printing recording apparatus of the present embodiment is not particularly limited as long as the ink composition is a composition or a liquid applicable to an ink jet method for textile printing. The ink composition may be, for example, a colored ink composition containing a colorant, or a functional liquid substantially free of colorants. Examples of the functional liquid include a clear ink, a reactive liquid, a softening liquid, and the like. The ink composition may contain the following components.

### Resin Particles

The ink composition may contain resin particles. The resin particles can improve the adhesion and abrasion resistance of an image due to the composition adhered to the fabric. Examples of the resin particles include resin particles made of a urethane-based resin, an acrylic-based resin (including styrene-acrylic-based resin), a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, an ethylene vinyl acetate resin, silicone-acrylic-based resin, and the like.

In addition, the ink composition may contain particles containing organopolysiloxane as resin particles. The particles containing organopolysiloxane are not particularly limited as long as the particles contain organopolysiloxane, and may be, for example, particles of organopolysiloxane itself or particles in a state in which the organopolysiloxane is dispersed with an emulsifier or the like. The property of the organopolysiloxane in the particles may be a solid or a liquid. For example, when an oily organopolysiloxane is dispersed in water in the form of particles by an emulsifier, the dispersed particles correspond to particles containing organopolysiloxane.

The resin particles can be used individually or in combination of two or more types.

A urethane-based resin is a general term for a resin having a urethane bond. For the urethane-based resin, a polyether-type urethane resin including an ether bond in the main chain, a polyester-type urethane resin including an ester bond in the main chain, and a polycarbonate-type urethane resin including a carbonate bond in the main chain, in addition to a urethane bond, and the like may be used. In addition, as the urethane-based resin, a commercially available product may be used. For example, commercially available products such as SUPERFLEX 460, 460s, 840, and E-4000 (trade names, manufactured by DKS Co., Ltd.), RESAMINE D-1060, D-2020, D-4080, D-4200, D-6300, and D-6455 (trade names, manufactured by Dainichiseika Color & Chemicals Mfg. Co., Ltd.), Takelac WS-6021, and W-512-A-6 (trade names, manufactured by Mitsui Chemicals & SKC Polyurethanes Inc.), Sancure 2710 (trade name, manufactured by Lubrizol Corporation), PERMARIN UA-150 (trade name, manufactured by Sanyo Chemical Industries Ltd.), ETERNACOLL UW series, for example, UW-1527 or the like, (manufactured by UBE Corporation), or the like may be used.

An acrylic-based resin is a general term for polymers obtained by polymerizing at least an acrylic monomer such as (meth)acrylic acid and (meth)acrylic acid ester as one component, and examples thereof include a resin obtained from an acrylic monomer, a copolymer of an acrylic monomer and a monomer other than acrylic monomer, and the like. Examples thereof include an acrylic-vinyl-based resin which is a copolymer of an acrylic monomer and a vinyl-based monomer and the like. In addition, examples of the vinyl-based monomer include styrene and the like.

As the acrylic monomer, acrylamide, acrylonitrile, and the like can also be used. For the resin emulsion using acrylic-based resin as a raw material, a commercially available product may be used. For example, any resin emulsion may be selected and used from FK-854 (trade name, manufactured by CHIRIKA Co., Ltd.), Mowinyl 952B, 718A, and 6760 (trade names, manufactured by Japan Coating Resin Corporation), Nipol LX852 and LX874 (trade names, manufactured by Zeon Corporation), or the like.

Incidentally, in the present specification, the acrylic-based resin may be a styrene-acrylic-based resin described below. In addition, in the present specification, the notation of “(meth)acrylic” means acrylic and methacrylic.

The styrene-acrylic-based resin is a copolymer obtained from a styrene monomer and a (meth)acrylic monomer, and examples thereof include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. As the styrene-acrylic-based resin, a commercially available product may be used. For example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Mowinyl 966A and 975N (trade names, manufactured by Japan Coating Resin Corporation), VINYBLAN 2586 (manufactured by Nissin Chemical Industry Co., Ltd.), or the like may be used.

As a silicone-acrylic copolymer resin, a commercially available product can be used. Examples thereof include CHALINE series FE-230N, FE-502, E-370, RU-911, R-170, R170S, LC-190, and R-170BX, manufactured by Nissin Chemical Industry Co., Ltd., SYMAC US-380, SYMAC US-450, and SYMAC US-480, manufactured by Toagosei Co., Ltd., IE-7170, SE 1980 CLEAR, BY22-826EX, and POLON-MF-40, manufactured by Dow Corning Toray Silicone Co., Ltd., LEXAN EXL manufactured by SABIC, TARFLON NEO manufactured by Idemitsu Kosan Co., Ltd., Banstar S-806 manufactured by Saiden Chemical Industry Co., Ltd., Mowinyl manufactured by Japan Coating Resin Corporation, COATAX manufactured by Toray Fine Chemicals Co., Ltd., DAITOSOL 5000SJ manufactured by Daito Kasei Kogyo Co., Ltd., YODOSOL GH41 manufactured by N.S.C. Japan, an acrylates/ethylhexyl acrylate/dimethicone methacrylate copolymer (trade name: KP578) manufactured by Shin-Etsu Chemical Co., Ltd., BONCOAT and CERANATE manufactured by DIC Corporation, and acrylic silicone-based emulsions “SIFCLEAR S101” and “SIFCLEAR S102” manufactured by JSR Corporation.

The polyolefin-based resin has an olefin such as ethylene, propylene, and butylene in the structural skeleton, and known ones can be appropriately selected and used. As the olefin resin, a commercially available product can be used. For example, ARROWBASE CB-1200 and CD-1200 (trade names, manufactured by Unitika Ltd.), or the like may be used.

In addition, the resin particles may be supplied in the form of an emulsion, and as examples of commercially available products of such a resin emulsion, any resin emulsion may be selected and used from Microgel E-1002 and E-5002 (trade names, manufactured by Nippon Paint Co. Ltd., styrene-acrylic-based resin emulsion), VONCOAT 4001 (trade name, manufactured by DIC Corporation, acrylic-based resin emulsion), VONCOAT 5454 (trade name, manufactured by DIC Corporation, styrene-acrylic-based resin emulsion), Polysol AM-710, AM-920, AM-2300, AP-4735, AT-860, and PSASE-4210E (acrylic-based resin emulsion), Polysol AP-7020 (styrene-acrylic resin emulsion), Polysol SH-502 (vinyl acetate resin emulsion), Polysol AD-13, AD-2, AD-10, AD-96, AD-17, and AD-70 (ethylene vinyl acetate resin emulsion), Polysol PSASE-6010 (ethylene vinyl acetate resin emulsion) (trade names, manufactured by Showa Denko KK), Polysol SAE1014 (trade name, styrene-acrylic-based resin emulsion, manufactured by Zeon Corporation), Saivinol SK-200 (trade name, acrylic-based resin emulsion, manufactured by Saiden Chemical Industry Co., Ltd.), AE-120A (trade name, manufactured by JSR Corporation, acrylic resin emulsion), AE373D (trade name, manufactured by Emulsion Technology Co., Ltd., carboxy-modified styrene-acrylic resin emulsion), Seikadyne 1900W (trade name, manufactured by Dainichiseika Color & Chemicals Mfg. Co., Ltd., ethylene vinyl acetate resin emulsion), VINYBLAN 2682 (acrylic resin emulsion), VINYBLAN 2886 (vinyl acetate acrylic resin emulsion), VINYBLAN 5202 (acetic acid acrylic resin emulsion) (trade names, manufactured by Nissin Chemical Industry Co., Ltd.), Elitel KA-5071S, KT-8803, KT-9204, KT-8701, KT-8904, and KT-0507 (trade names, manufactured by Unitika Ltd., polyester resin emulsion), Hi-Tech SN-2002 (trade name, manufactured by TOHO CHEMICAL INDUSTRY Co., Ltd., polyester resin emulsion), TAKELAK W-6020, W-635, W-6061, W-605, W-635, W-6021, and WS-5100 (trade names, manufactured by Mitsui Chemicals & SKC Polyurethanes Inc., urethane-based resin emulsion), SUPERFLEX 870, 800, 150, 420, 460, 470, 610, and 700 (trade names, manufactured by DKS Co., Ltd., urethane-based resin emulsion), PERMARIN UA-150 (manufactured by Sanyo Chemical Industries, Ltd., urethane-based resin emulsion), Sancure 2710 (manufactured by Japanese Lubrizol Corporation, urethane-based resin emulsion), NeoRez R-9660, R-9637, and R-940 (manufactured by Kusumoto Chemicals, Ltd., urethane-based resin emulsion), ADEKA BONTIGHTER HUX-380 and 290K (manufactured by ADEKA Corporation, urethane-based resin emulsion), Mowinyl 966A and Mowinyl 7320 (manufactured by Japan Coating Resin Corporation), Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (manufactured by BASF SE), NK binder R-5HN (manufactured by Shin-Nakamura Chemical Co., Ltd.), HYDRAN WLS-210 (non-crosslinkable polyurethane: manufactured by DIC Corporation), and Joncryl 7610 (manufactured by BASF SE).

In addition, particles (emulsions) of cationic resins (cationic polymers) may be used as the resin particles. Examples of such resin particles include particles of cationic urethane-based resins, cationic olefin-based resins, and cationic amine-based resins.

As cationic urethane-based resins, commercially available products can be used. For example, Hydran CP-7010, CP-7020, CP-7030, CP-7040, CP-7050, CP-7060, CP-7610 (trade names, manufactured by Dainippon Ink and Chemicals, Inc.), Superflex 600, 610, 620, 630, 640, 650 (trade names, manufactured by DKS Co., Ltd.), Urethane Emulsion WBR-2120C, WBR-2122C (trade names, manufactured by Taisei Fine Chemical Co., Ltd.), Movinyl 7820 (trade name: manufactured by Japan Coating Resin Co., Ltd.), or the like can be used.

The cationic olefin resin is a resin having an olefin such as ethylene and propylene in the structural skeleton, and known ones can be appropriately selected and used. In addition, the cationic olefin resin may be in an emulsion state of being dispersed in a solvent containing water, an organic solvent, or the like. As the cationic olefin resin, a commercially available product can be used, and examples thereof include ARROW BASE CB-1200 and CD-1200 (trade names, manufactured by Unitika Ltd.).

As the cationic amine-based resin (cationic polymer), any resin having an amino group in the structure may be used, and known ones can be appropriately selected and used. Examples thereof include polyamine resin, polyamide resin, polyallylamine resin, and the like. Polyamine resin is a resin having an amino group in the main skeleton of the resin. Polyamide resin is a resin having an amide group in the main skeleton of the resin. Polyallylamine resin is a resin having a structure derived from an allyl group in the main skeleton of the resin.

In addition, as the cationic polyamine-based resin, Unisense KHE103L (hexamethylenediamine/epichlorohydrin resin, 1% aqueous solution of a pH of substantially 5.0, viscosity: 20 to 50 (mPa·s), an aqueous solution with a solid component concentration of 50% by mass) manufactured by Senka Co., Ltd., Unisense KHE104L (dimethylamine/epichlorohydrin resin, 1% aqueous solution of a pH of substantially 7.0, viscosity: 1 to 10 (mPa·s), an aqueous solution with a solid component concentration of 20% by mass), and the like can be used. In addition, specific examples of commercially available products of the cationic polyamine-based resin include FL-14 (manufactured by SNF Co. Ltd.), ARAFIX 100, 251S, 255, and 255LOX (manufactured by Arakawa Chemical Industries, Ltd.), DK-6810, 6853, and 6885, and WS-4010, 4011, 4020, 4024, 4027, and 4030 (manufactured by Seiko PMC Corporation), Papiogen P-105 (manufactured by Senka Co., Ltd.), Sumirez Resin 650 (30), 675A, 6615, and SLX-1 (manufactured by Taoka Chemical Co., Ltd.), Catiomaster (registered trademark) PD-1, 7, 30, A, PDT-2, PE-10, PE-30, DT-EH, EPA-SK01, and TMHMDA-E (manufactured by Yokkaichi Chemical Company, Limited), and Jetfix 36N, 38A, 5052 (manufactured by Satoda Kako Co., Ltd.).

Examples of the polyamine-based resin include a polyallylamine resin. Examples of the polyallylamine resin include polyallylamine hydrochloride, polyallylamineamide sulfate, allylamine hydrochloride/diallylamine hydrochloride copolymers, allylamine acetate/diallylamine acetate copolymers, allylamine hydrochloride/dimethylallylamine hydrochloride copolymers, allylamine/dimethylallylamine copolymers, polydiallylamine hydrochloride, polymethyldiallylamine hydrochloride, polymethyldiallylamineamide sulfate, polymethyldiallylamine acetate, polydiallyldimethylammonium chloride, diallylamine acetate/sulfur dioxide copolymers, diallylmethylethylammonium ethylsulfate/sulfur dioxide copolymers, methyldiallylamine hydrochloride/sulfur dioxide copolymers, diallyldimethylammonium chloride/sulfur dioxide copolymers, and diallyldimethylammonium chloride/acrylamide copolymers.

The ink composition may contain organopolysiloxane as resin particles. In addition, the ink composition may be a functional liquid containing organopolysiloxane. The ink composition contains organopolysiloxane, and thus the ink composition can function as a softening liquid, and the texture and color development of the printed textiles can be easily improved.

Organopolysiloxane is a general term for organic silicon compounds having a siloxane bond “—Si(R¹R²)—O—” as a skeleton, in which a methyl group, a phenyl group, a vinyl group, an amino group, or the like is bonded to the siloxane bond as organic groups R¹ and R². Due to the chemical composition and the molecular weight, the organopolysiloxane exhibits oil-like (oily), rubber-like, or resin-like properties, and is referred to as silicone oil, silicone rubber, or silicone resin, respectively.

When organopolysiloxane is used as resin particles in the ink composition of the present embodiment, it is more preferable that the organopolysiloxane is an oily compound. When the organopolysiloxane is an oily compound, the organopolysiloxane is easily and stably dispersed in the form of particles in an aqueous matrix by an emulsification treatment.

The molecular structure of the organopolysiloxane is not particularly limited, and examples thereof include linear, branched, cyclic, grid-like, cage-like structures, and other structures. When the molecular structure of the organopolysiloxane is an acyclic structure, one or two or more groups selected from a hydrocarbon group, an alkoxy group, a hydroxyl group, a hydrogen atom, and a halogen, which may have a substituent, are usually bonded to the terminal Si atom of this molecule.

The organopolysiloxane is not particularly limited, and examples thereof include dimethyl silicone, alkyl-modified silicone, amino-modified silicone, epoxy-modified silicone, cyclic silicone, methyl phenyl silicone, and other silicones. These may be used alone or as a mixture of two or more types thereof.

In addition, as the organopolysiloxane, those commercially available as silicone oils may be used. Examples thereof include dimethyl silicone oil, methyl phenyl silicone oil, methyl hydrogen silicone oil, polyether-modified silicone oil, aralkyl-modified silicone oil, fluoroalkyl-modified silicone oil, long-chain alkyl-modified silicone oil, higher fatty acid ester-modified silicone oil, higher fatty acid amide-modified silicone oil, polyether/long-chain alkyl/aralkyl-modified silicone oil, long-chain alkyl/aralkyl-modified silicone oil, phenyl-modified silicone oil, and polyether/methoxy-modified silicone oil.

In addition, among the above-exemplified organopolysiloxanes, it is more preferable that the organopolysiloxane is a nonionic silicone. In addition, among the above-exemplified organopolysiloxanes, it is more preferable that the organopolysiloxane is an unmodified silicone. Such organopolysiloxanes are chemically more stable and are less likely to cause yellowing or the like of an image to be formed.

Further, the organopolysiloxane is more preferably one or more selected from dimethyl silicone, methyl phenyl silicone, and methyl hydrogen silicone.

Examples of commercially available products of silicone oils include dimethyl silicone (KF-96 series, manufactured by Shin-Etsu Chemical Co., Ltd.), methyl hydrogen type polysiloxane (KF-99 series, KF-9901, and the like, manufactured by Shin-Etsu Chemical Co., Ltd.), methyl phenyl silicone (KF-50 series and the like, manufactured by Shin-Etsu Chemical Co., Ltd.), amino-modified silicone (KF-868, and the like, manufactured by Shin-Etsu Chemical Co., Ltd.), and silicone-branched silicone treatment agents (KF-9908, KF-9909, and the like, manufactured by Shin-Etsu Chemical Co., Ltd.).

For example, the viscosity of the silicone at 25 °C is not particularly limited, but is preferably 1000 mPa·s or less, more preferably 50 mPa·s or more, even more preferably 500 mPa·s or more and 900 mPa·s or less, and still even more preferably 600 mPa·s or more and 700 mPa·s or less. In addition, the base oil viscosity when the silicone is emulsified and dispersed is not particularly limited, but the upper limit is preferably 1,000,000 mm²/s or less, and more preferably 100,000 mm²/s or less, and the lower limit is preferably 10 mm²/s or more, and more preferably 100 mm²/s or more. The base oil viscosity indicates the viscosity of the base oil and is a numerical value obtained by measuring the magnitude of the internal resistance of the base oil. The higher the numerical value of the base oil viscosity, the higher the viscosity, and the smaller the numerical value of the base oil viscosity, the lower the viscosity.

The organopolysiloxane may be blended in the form of particles by emulsifying various surfactants as emulsifiers. As the emulsifiers at that time, for example, nonionic surfactants, negative ion (anionic) surfactants, positive ion (cationic) surfactants, amphoteric surfactants, phospholipid, or the like can be used.

Examples of the nonionic surfactants include glycerin fatty acid esters, polyglycerin fatty acid esters, propylene glycol fatty acid esters, sorbitan fatty acid esters, fatty acid esters of sorbitol and alkylene glycol adducts thereof, polyalkylene glycol fatty acid esters, sucrose fatty acid esters, polysorbate 20, polysorbate 60, polysorbate 80, polyoxyalkylene alkyl ethers, and polyoxyethylene alkylphenyl ethers.

In addition, as the nonionic surfactant, for example, nonionic surfactants such as polyoxyethylene glycerin fatty acid ester, polyglycerin fatty acid esters, sorbitan fatty acid ester, polyoxyethylene sorbitan fatty acid ester, polyoxyethylene sorbitol fatty acid ester, polyethylene glycol fatty acid ester, polyoxyethylene castor oil, polyoxyethylene hardened castor oil, polyoxyethylene phytosterol, polyoxyethylene polyoxypropylene alkyl ether, polyoxyethylene lanolin, polyoxyethylene lanolin alcohol, polyoxyethylene beeswax derivatives, polyoxyethylene alkylamine, polyoxyethylene fatty acid amide, polyoxyethylene alkylphenyl formaldehyde condensates, polyoxyethylene alkyl ether phosphoric acid (salt), and the like are suitably used.

Examples of the anionic surfactants include alkyl sulfate ester salt, polyoxyethylene alkyl sulfate ester salt, alkyl benzene sulfonate, and α-olefin sulfonate. Examples of the cationic surfactant include alkyltrimethylammonium chloride, dialkyldimethylammonium chloride, and benzalkonium chloride. Examples of the amphoteric surfactant include alkyl dimethyl aminoacetic acid betaine, and alkyl amido dimethyl aminoacetic acid betaine. Further, naturally derived surfactants may be used, and examples thereof include lecithin, lanolin, cholesterol, and saponin.

The blending amount of the emulsifier when emulsifying the organopolysiloxane is preferably less than 20% by mass, more preferably 15% by mass or less, and particularly preferably 10% by mass or less, of the total amount of the emulsion composition.

In addition, it is desirable that the average particle diameter of the particles of the emulsified particulate organopolysiloxane is 2 μm or less, preferably 1 μm or less, and more preferably within a range of 0.05 to 0.5 μm.

The total content of the resin particles in the ink composition is preferably 1% by mass or more and 15% by mass or less, more preferably 2% by mass or more and 10% by mass or less, and even more preferably 2.5% by mass or more and 8% by mass or less, relative to the total amount of the ink composition. By keeping the content of resin particles within the above range, there is a tendency to improve the color development, fixability, and abrasion resistance of the ink composition adhered to the recording medium.

In addition, when the ink composition contains organopolysiloxane as resin particles, the ink composition can function as a softening liquid. That is, when the ink composition contains organopolysiloxane as resin particles, the ink composition can be a functional liquid that imparts softening properties to a recorded matter or an image. In this way, it is easier to obtain better texture and color development (higher density) for recorded matter, and although problems with contamination of the endless belt are prone to occur, excellent cleaning performance can be achieved with the cleaning liquid.

### Water

The ink composition according to the present embodiment may contain water. Examples of water include pure water such as ion exchange water, ultrafiltered water, reverse osmosis water, and distilled water, and water such as ultrapure water, from which ionic impurities are removed as much as possible. In addition, when water sterilized by irradiation with ultraviolet rays, addition of hydrogen peroxide, or the like is used, the generation of bacteria or fungi when the composition is stored for a long period of time can be reduced.

The content of water is 30% by mass or more, preferably 40% by mass or more, more preferably 45% by mass or more, and even more preferably 50% by mass or more relative to the total amount of the ink composition. When the water content is set to 30% by mass or more, the ink composition can have a relatively low viscosity. Further, the upper limit of the content of the water is preferably 90% by mass or less, more preferably 85% by mass or less, and even more preferably 80% by mass or less, relative to the total amount of the ink composition. In the present specification, the term “aqueous composition” refers to a composition containing 30% by mass or more of water relative to the total mass (100% by mass) of the composition.

### Colorant

The ink composition may contain a pigment as a colorant, and may be a so-called pigment color ink. Examples of the pigment contained in the ink composition include color pigments such as cyan, yellow, magenta, and black, and special color pigments such as white and pearl.

The pigment may be a mixture. The pigment is excellent in storage stability such as light resistance, weather resistance, and gas resistance, and is preferably an organic pigment from that viewpoint.

Specifically, as the pigment, azo pigments such as insoluble azo pigments, condensed azo pigments, azo lakes, and chelated azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, daylight fluorescent pigments, carbon black, and the like can be used. These pigments may be used alone or in combination of two or more thereof. Further, a white pigment, a photoluminescent pigment, or the like may be used as the pigment.

Specific examples of the pigments are not particularly limited and examples thereof include the following.

Examples of black pigments include No. 2300, No. 900, MCF 88, No. 33, No. 40, No. 45, No. 52, MA7, MA8, MA100, and No. 2200 B (all manufactured by Mitsubishi Chemical Corporation), Raven 5750, Raven 5250, Raven 5000, Raven 3500, Raven 1255, and Raven 700 (all manufactured by Carbon Columbia), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (manufactured by CABOT JAPAN K.K.), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all manufactured by Degussa).

Examples of yellow pigments include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of magenta pigments include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, or C.I. Pigment Violet 19, 23, 32, 33, 36, 38, 43, and 50.

Examples of cyan pigments include C.I. Pigment Blue 1, 2, 3, 15, 15:1, 15:2, 15:3, 15:34, 15:4, 16, 18, 22, 25, 60, 65, and 66, and C.I. Vat blue 4 and 60.

In addition, pigments other than the magenta, cyan, and yellow pigments are not particularly limited and examples thereof include C.I. Pigment Green 7, 10, C.I. Pigment Brown 3, 5, 25, 26, and C.I. Pigment Orange 1, 2, 5, 7, 13, 14, 15, 16, 24, 34, 36, 38, 40, 43, and 63.

The pearl pigment is not particularly limited and examples thereof include pigments having pearl luster or interference luster such as titanium dioxide coated mica, fish scale foil, and bismuth oxychloride.

The metallic pigment is not particularly limited and examples thereof include particles formed of aluminum, silver, gold, platinum, nickel, chromium, tin, zinc, indium, titanium, copper, and the like, alone or in alloys.

Examples of the white pigment include metal compounds such as metal oxide, barium sulfate, and calcium carbonate. Examples of the metal oxide include titanium dioxide, zinc oxide, silica, alumina, magnesium oxide, and the like. In addition, particles having a hollow structure may be used as the white pigment, and as the particles having a hollow structure, known particles can be used.

Preferably, the pigment can be stably dispersed in a dispersion medium, and for this purpose, a dispersant may be used for the dispersion of the pigment. As the dispersant, there is provided a resin dispersant and the like, and the dispersant is selected from those that can improve dispersion stability of the pigment in the ink composition. In addition, the pigment may also be used as a self-dispersing pigment by modifying the surface of the pigment particles by oxidizing or sulfonating the pigment surface with, for example, ozone, hypochlorous acid, fuming sulfuric acid, or the like.

Examples of the resin dispersant (dispersant resin) include (meth)acrylic-based resins such as poly(meth)acrylic acid, (meth)acrylic acid-acrylonitrile copolymers, (meth)acrylic acid-(meth)acrylic acid ester copolymers, vinyl acetate-(meth)acrylic acid ester copolymers, vinyl acetate-(meth)acrylic acid copolymers, and vinyl naphthalene-(meth)acrylic acid copolymers, and salts thereof, styrene-based resins such as styrene-(meth)acrylic acid copolymers, styrene-(meth)acrylic acid-(meth)acrylic acid ester copolymers, styrene-α-methylstyrene-(meth)acrylic acid copolymers, styrene-α-methylstyrene-(meth)acrylic acid-(meth)acrylic acid ester copolymers, styrene-maleic acid copolymers, and styrene-maleic acid anhydride copolymers, and salts thereof, urethane-based resins, which are polymer compounds (resins) having a urethane bond formed when an isocyanate group reacts with a hydroxyl group, and which may be linear and/or branched regardless of a crosslinked structure, and salts thereof, polyvinyl alcohols, vinyl naphthalene-maleic acid copolymers and salts thereof, vinyl acetate-maleic acid ester copolymers and salts thereof, and water-soluble resins such as vinyl acetate-crotonic acid copolymers and salts thereof. Among these, a copolymer of a monomer having a hydrophobic functional group and a monomer having a hydrophilic functional group, and a polymer formed of monomers having both a hydrophobic functional group and a hydrophilic functional group are preferable. As the form of the copolymer, any form of a random copolymer, a block copolymer, an alternating copolymer, and a graft copolymer can be used.

Examples of commercially available products of the styrene-based resin dispersant include X-200, X-1, X-205, X-220, and X-228 (manufactured by SEIKO PMC CORPORATION), NOPCOSPERSE (registered trademark) 6100 and 6110 (manufactured by SAN NOPCO LIMITED), Joncryl 67, 586, 611, 678, 680, 682, and 819 (manufactured by BASF SE), DISPER BYK-190 (manufactured by BYK Japan KK.), and N-EA137, N-EA157, N-EA167, N-EA177, N-EA197D, N-EA207D, and E-EN10 (manufactured by DKS Co., Ltd.).

In addition, examples of commercially available products of the acrylic-based resin dispersants include BYK-187, BYK-190, BYK-191, BYK-194N, and BYK-199 (manufactured by BYK Japan KK.), and Aron A-210, A6114, AS-1100, AS-1800, A-30SL, A-7250, and CL-2 (manufactured by TOAGOSEI CO., LTD.).

Further, examples of commercially available products of the urethane-based resin dispersant include BYK-182, BYK-183, BYK-184, and BYK-185 (manufactured by BYK Japan KK.), TEGO Dispers 710 (manufactured by Evonik Tego Chemi GmbH), and Borchi (registered trademark) Gen 1350 (manufactured by OMG Borchers GmbH).

These dispersants may be used alone or in combination of two or more thereof. The total content of the dispersant is preferably 0.1 parts by mass or more and 30 parts by mass or less, more preferably 0.5 parts by mass or more and 25 parts by mass or less, even more preferably 1 part by mass or more and 20 parts by mass or less, and still even more preferably 1.5 parts by mass or more and 15 parts by mass or less, relative to 50 parts by mass of the pigment. When the content of the dispersant is 0.1 parts by mass or more with respect to 50 parts by mass of the pigment, the dispersion stability of the pigment can be further enhanced. In addition, when the content of the dispersant is 30 parts by mass or less with respect to 50 parts by mass of the pigment, the viscosity of the obtained dispersion can be suppressed to be small.

By using such a resin dispersant as the dispersant, the dispersion and cohesion of the pigment are further improved, and an image having more favorable dispersion stability and more favorable image quality can be obtained.

The dispersant resin preferably has an acid value, and the acid value is preferably 5 mg KOH/g or more, more preferably 10 to 200 mg KOH/g, and even more preferably 15 to 150 mg KOH/g. Further, an acid value of 20 to 100 mg KOH/g is preferable, and an acid value of 25 to 70 mg KOH/g is more preferable.

The acid value can be measured by the neutralization titration method in accordance with JIS K 0070. As a titration device, for example, “AT610” manufactured by Kyoto Electronics Manufacturing Co., Ltd. can be used.

When the ink composition contains a pigment, the content of the pigment is preferably 0.3% by mass or more and 20% by mass or less, and more preferably 0.5% by mass or more and 15% by mass or less, based on the total mass of the ink composition. Further, the content is preferably 1% by mass or more and 10% by mass or less, and more preferably 2% by mass or more and 7% by mass or less.

When the ink composition contains a pigment, the ink composition becomes a colored ink composition. When the ink composition is a colored ink composition, the solid components (resin, pigment) tend to increase, making it easier to reduce the adhesion of the glue layer (pressure sensitive layer) of the fabric transport member such as an endless belt. However, by using the cleaning liquid of the present embodiment, the transportability of the fabric transport member can be maintained well even when such a colored ink composition is used. In addition, when the ink composition contains a pigment, the ink composition can be a colored ink composition, and the solid component of the colored ink composition such as a resin and a pigment is relatively large. Therefore, the adhesive force of the pressure sensitive adhesive layer of the endless belt is more likely to decrease. However, according to the ink jet textile printing recording apparatus, the decrease in adhesive force can be reduced, and since the colored ink composition is a pigment ink, the cleaning step after the textile printing can be omitted or simplified.

On the other hand, when the ink composition contains the above-mentioned organopolysiloxane compound, the ink composition may be substantially free of colorants. By doing so, the ink composition can function as a clear ink and a softening liquid. In this way, it is easier to obtain better texture and color development (higher density) for recorded matter, and although problems with contamination of the fabric transport member are prone to occur, excellent cleaning performance can be achieved with the cleaning liquid. In this way, the ink composition can be a functional liquid such as a softening liquid or coating liquid, making it easier to obtain a better texture for recorded matter, and although problems with contamination of a fabric transport member such as an endless belt are prone to occur, excellent cleaning performance can be achieved with the cleaning liquid.

When the ink jet composition is a functional liquid containing the organopolysiloxane compound mentioned above, the content of particles containing organopolysiloxane is preferably 90.0% by mass or more relative to the total solid components of the functional liquid. That is, it is preferable that 90.0% by mass or more of the solid components remaining when the functional liquid is dried is organopolysiloxane. The content of particles containing organopolysiloxane relative to the total solid components in the functional liquid is more preferably 95.0% by mass or more, further preferably 98% by mass or more, and particularly preferably 99.0% by mass or more.

When the content of particles containing organopolysiloxane relative to the total solid components in the functional liquid is 90% by mass or more, it tends to be easier to form a coating film with a sufficiently low refractive index, and an image can be formed with better color development. Further, the texture of the recorded matter can be further improved. In addition, when the treatment solution composition is ejected by an ink jet method, the ejection stability is likely to be further favorable.

In the present specification, “substantially free of a certain component” refers to the content of the component being 0.1% by mass or less, preferably 0.01% by mass or less, and more preferably 0.001% by mass or less, relative to the total amount of the composition, and most preferably, it means that the component is not contained at all.

### Organic Solvent

The ink composition may contain an organic solvent. It is preferable that the organic solvent is a water-soluble organic solvent. One of the functions of the organic solvent is to improve the wettability of the ink composition with respect to a fabric or to enhance the moisture retention properties of the ink composition. The organic solvent can also function as a penetrant.

Examples of the organic solvent include esters, alkylene glycol ethers, cyclic esters, nitrogen-containing solvents, and polyhydric alcohols. Examples of the nitrogen-containing solvents include cyclic amides and acyclic amides. Examples of the acyclic amides include alkoxyalkylamides and the like.

Examples of the esters include glycol monoacetates such as ethylene glycol monomethyl ether acetate, ethylene glycol monoethyl ether acetate, and ethylene glycol monobutyl ether acetate, and glycol diesters such as ethylene glycol diacetate, diethylene glycol diacetate, and propylene glycol diacetate.

Examples of the cyclic esters include cyclic esters (lactones) such as β-propiolactone, γ-butyrolactone, δ-valerolactone, ε-caprolactone, and β-butyrolactone, and compounds in which a hydrogen of a methylene group adjacent to a carbonyl group thereof is substituted with an alkyl group having 1 to 4 carbon atoms.

Examples of the alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, and 3-n-butoxy-N,N-methylethylpropionamide.

Examples of the cyclic amides include lactams, and examples thereof include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone.

In addition, it is also preferable to use compounds represented by Formula (1) as the alkoxyalkylamides.

R¹—O—CH₂CH₂—(C═O)—NR²R³ . . . (1)

In Formula (1), R¹ represents an alkyl group having 1 or more and 4 or fewer carbon atoms, and R² and R³ each independently represent a methyl group or an ethyl group. The “alkyl group having 1 or more and 4 or fewer carbon atoms” may be a linear or branched alkyl group, and examples thereof include a methyl group, an ethyl group, an n-propyl group, an iso-propyl group, an n-butyl group, a sec-butyl group, an iso-butyl group, and a tert-butyl group. The compounds represented by Formula (1) may be used alone or as a mixture of two or more thereof.

Examples of the polyhydric alcohols include 1,2-alkanediol (for example, alkanediols such as ethylene glycol, propylene glycol (alias: propane-1,2-diol), 1,2-butanediol, 1,2-pentanediol, 1,2-hexanediol, 1,2-heptanediol, and 1,2-octanediol), and polyhydric alcohols (polyols) excluding the 1,2-alkanediol (for example, diethylene glycol, dipropylene glycol, 1,3-propanediol, 1,3-butanediol (alias: 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylol propane, and glycerin).

The polyhydric alcohols may include alkanediols and polyols. The alkanediols are diols of an alkane having 5 or more carbon atoms. The number of carbon atoms of the alkane is preferably 5 to 15, more preferably 6 to 10, and even more preferably 6 to 8. 1,2-alkanediol is preferable.

The polyols are polyols of alkane having 4 or fewer carbon atoms or intermolecular condensates of hydroxyl groups of polyols of alkane having 4 or fewer carbon atoms. The number of carbon atoms of the alkane is preferably 2 to 3. The number of the hydroxyl groups in the molecule of the polyols is 2 or more, preferably 5 or fewer, and more preferably 3 or fewer. When the polyols are the intermolecular condensates described above, the number of intermolecular condensates is 2 or more, preferably 4 or fewer, and more preferably 3 or fewer. The polyhydric alcohols may be used alone or as a mixture of two or more types thereof.

The alkanediols and polyols can mainly function as a penetrating solvent and/or a moisturizing solvent. However, the alkanediols tend to have strong properties as the penetrating solvent, and polyols tend to have strong properties as the moisturizing solvent.

One kind of organic solvent may be used alone, or two or more kinds thereof may be used in combination. When the ink composition contains an organic solvent, the content of the organic solvent can be 1% by mass or more and 50% by mass or less relative to the total amount of the ink composition, preferably 3% by mass or more and 40% by mass or less, and more preferably 5% by mass or more and 30% by mass or less.

### Surfactant

The ink composition according to the present embodiment may contain a surfactant. The surfactant has a function of adjusting the surface tension of the composition and adjusting, for example, the wettability with the fabric. Among the surfactants, for example, acetylene glycol-based surfactant, silicone-based surfactant, and fluorine-based surfactant can be preferably used.

The acetylene glycol-based surfactant is not particularly limited and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all trade names, manufactured by Air Products & Chemicals, Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all trade names, manufactured by Nissin Chemical Industry Co., Ltd.), and ACETYLENOL E00, E00P, E40, and E100 (all trade names, manufactured by Kawaken Fine Chemicals Co., Ltd.).

The silicone-based surfactant is not particularly limited and examples thereof preferably include a polysiloxane-based compound. The polysiloxane-based compound is not particularly limited and examples thereof include polyether-modified organosiloxane. Examples of commercially available products of the polyether-modified organosiloxane include BYK-306, BYK-307, BYK-333, BYK-341, BYK-345, BYK-346, and BYK-348 (all trade names, manufactured by BYK Japan KK.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all trade names, manufactured by Shin-Etsu Chemical Co., Ltd.), and SILFACE SAG002, 005, 503A, 008 (all trade names, manufactured by Nissin Chemical Industry Co., Ltd.).

As the fluorine-based surfactant, a fluorine-modified polymer is preferably used, and specific examples thereof include BYK-3440 (manufactured by BYK Japan KK.), SURFLON S-241, S-242, and S-243 (all trade names, manufactured by AGC SEIMI CHEMICAL CO., LTD.), and FTERGENT 215M (manufactured by NEOS COMPANY LIMITED).

When the ink composition contains a surfactant, a plurality of types of surfactants may be contained. When the ink composition contains a surfactant, the content thereof can be set to 0.1% by mass or more and 2% by mass or less, preferably 0.3% by mass or more and 1.5% by mass or less, and more preferably 0.4% by mass or more and 1.0% by mass or less relative to the total mass of the ink composition.

### Coagulant

The ink composition may contain a coagulant. When the ink composition contains a coagulant, the ink composition can be a functional liquid (reactive liquid) having a function of coagulating pigments and resin particles by reacting with components such as pigments and resin particles contained in other ink compositions used together. The coagulant has the effect of coagulating pigments and resin particles by reacting with components such as pigments and resin particles contained in the ink composition or other ink compositions used together. Through such coagulation, for example, the color development of the pigment can be enhanced, the fixability of resin particles can be improved, and/or the viscosity of the composition can be increased.

When the ink jet composition is a composition containing a coagulant (hereinafter also referred to as a reactive liquid), it is preferable that the reactive liquid is free of a pigment. Further, it is preferable that the reactive liquid is free of resin particles that react with the coagulant. Examples of resin particles that react with the coagulant include anionic resin particles.

The coagulant is not particularly limited and examples thereof include metal salts, inorganic acids, organic acids, and cationic compounds. Among the compounds, particles of the aforementioned cationic resins (cationic polymers) as cationic compounds also correspond to the resin particles mentioned above.

When the ink composition contains a coagulant as a functional liquid, the total content of the coagulant in the ink composition is not limited, but for example, is 0.1% by mass or more and 15% by mass or less based on the total mass of the composition, preferably 1% by mass or more and 10% by mass or less, and more preferably 2% by mass or more and 10% by mass or less.

### Other Components

The ink composition may contain the following components in addition to the above components.

### pH Adjusting Agent

The ink composition according to the present embodiment may further contain a pH adjusting agent. The pH adjusting agent is not particularly limited and examples thereof include an appropriate combination of an acid, a base, a weak acid, and a weak base. Examples of acids and bases used in such combinations include, as inorganic acids, sulfuric acid, hydrochloric acid, nitric acid, and the like as inorganic bases, lithium hydroxide, sodium hydroxide, potassium hydroxide, potassium dihydrogen phosphate, disodium hydrogen phosphate, potassium carbonate, sodium carbonate, sodium bicarbonate, ammonia and the like as organic bases, triethanolamine, tripropanolamine, diethanolamine, monoethanolamine, triisopropanolamine, diisopropanolamine, tris(hydroxymethyl)aminomethane (THAM), and as organic acids, adipic acid, citric acid, succinic acid, lactic acid, and Good's buffers such as N,N-bis(2-hydroxyethyl)-2-aminoethanesulfonicacid (BES), 4-(2-hydroxyethyl)-1-piperazineethanesulfonic acid (HEPES), morpholinoethanesulfonic acid (MES), morpholinopropanesulfonic acid (MOPS), N-(carbamoylmethyl)iminodiacetic acid (ADA), piperazine-1,4-bis(2-ethanesulfonic acid) (PIPES), N-(2-acetamido)-2-aminoethanesulfonic acid (ACES), cholamine hydrochloride, N-tris(hydroxymethyl)methyl-2-aminoethanesulfonic acid (TES), acetamidoglycine, tricine, glycinamide, bicine, as well as phosphate buffer, citrate buffer, Tris buffer, and the like.

### Fatty Acid Ester

The ink composition according to the present embodiment may further contain a fatty acid ester. Examples of the fatty acid ester include polyoxyethylene monocaprate, polyoxyethylene monocaprylate, polyoxyethylene monolaurate, polyoxyethylene monomyristylate, polyoxyethylene monopalmitate, polyoxyethylene monostearate, polyoxyethylene monooleate, polyoxyethylene monoisostearate, polyoxyethylene monobehenate, polyoxyethylene dicaprate, polyoxyethylene dicaprylate, polyoxyethylene dilaurate, polyoxyethylene dimyristylate, polyoxyethylene dipalmitate, polyoxyethylene distearate, polyoxyethylene dioleate, polyoxyethylene diisostearate, and polyoxyethylene dibehenate.

### Dialkyldimethylammonium Salt

The ink composition according to the present embodiment may further contain a dialkyldimethylammonium salt. Examples of the dialkyldimethylammonium salt include dioleoyloxytrimethylammonium propane chloride (DOTAP), dioctadecenyltrimethylammonium propane chloride (DOTMA), didecyldimethylammonium chloride, didecyldimethylammonium bromide, dicocoyldimethylammonium chloride, dicocoyldimethylammonium bromide, dilauryldimethylammonium chloride, dicetyldimethylammonium chloride, dicetyldimethylammonium bromide, distearyldimethylammonium chloride, distearyldimethylammonium bromide, dioleyldimethylammonium chloride, dibehenyldimethylammonium chloride, dibehenyldimethylammonium bromide, dialkyldimethylammonium chloride, dialkyldimethylammonium bromide, dicocoylethyl hydroxyethylmonium methosulfate, dipalmitoylethyl hydroxyethylmonium methosulfate, and distearoylethylhydroxyethylmonium methosulfate.

### Imidazoline-Type Surfactant

The ink composition according to the present embodiment may further contain an imidazoline-type surfactant. Examples of the imidazoline-type surfactant include 1-hydroxyethyl-2-lauryl imidazoline, 1-aminoethyl-2-lauryl imidazoline, 1-hydroxyethyl-2-myristyl imidazoline, 1-aminoethyl-2-myristyl imidazoline, 1-hydroxyethyl-2-palmityl imidazoline, 1-aminoethyl-2-palmityl imidazoline, 1-hydroxyethyl-2-oleyl imidazoline, 1-aminoethyl-2-oleyl imidazoline, 1-hydroxyethyl-2-stearyl imidazoline, 1-aminoethyl-2-stearyl imidazoline, 2-alkyl-N-carboxymethylimidazolinium betaine, 2-alkyl-N-carboxyethyl imidazolinium betaine, and 2-alkyl-N-carboxymethyl-N-hydroxyethylimidazolinium betaine.

### Amphoteric Surfactant

The ink composition according to the present embodiment may further contain an amphoteric surfactant. Examples of the amphoteric surfactant include alkyl carboxybetaine, alkyl sulfobetaine, alkyl hydroxy sulfobetaine, alkylamide betaine, lauryl dimethylamine oxide, and lauric acid amidopropyl dimethylamine oxide.

### Water-Soluble Resin

The ink composition according to the present embodiment may further contain a water-soluble resin. The water-soluble resin is not particularly limited and examples thereof include carboxymethyl cellulose, hydroxyethyl cellulose, polyvinylpyrrolidone, and polyethylene oxide. Among these, a nonionic resin is more preferable, and for example, polyvinylpyrrolidone is more preferable. The polyvinylpyrrolidone is not limited to a homopolymer, and a copolymer of vinylpyrrolidone and other monomers may be used. Examples of commercially available products of polyvinylpyrrolidone include polyvinylpyrrolidone K-30 and K-30W (hereinabove, all trade names, manufactured by Nippon Shokubai Co., Ltd.), PITZCOL (registered trademark) K-17L, K-30, K-30L, and K-30AL, K-60L, K-50, K-90, CREEJUS (registered trademark) K-30, and AIPHTACT (registered trademark) K-30PH (hereinabove, all trade names, manufactured by DKS Co., Ltd.), and PVP K-30, PVP K-25, and PVP K-17 (trade names, manufactured by Ashland).

### Moisturizing Agent

The ink composition according to the present embodiment may further contain a moisturizing agent. The moisturizing agent is not particularly limited and examples thereof include glycerin, 2-pyrrolidone, urea, triethanolamine, propylene glycol, 1-(2-hydroxyethyl)-2-pyrrolidone, trimethylolpropane, triethylene glycol, 1,5-pentanediol, triethylene glycol monomethyl ether, and amino coat. Among these, one moisturizing agent can be used alone or two or more thereof can be used in combination.

### Additive

The ink composition according to the present embodiment may further contain an additive. Examples of the additive include saccharides, chelating agents, preservatives/antifungal agents, rust inhibitors, and the like.

Specific examples of saccharides include glucose, mannose, fructose, ribose, xylose, arabinose, galactose, aldonic acid, glucitol (sorbitol), maltose, cellobiose, lactose, sucrose, trehalose, and maltotriose.

Examples of the chelating agent include ethylenediaminetetraacetic acid and salts thereof (such as ethylenediaminetetraacetic acid dihydrogen disodium salt, ethylene diamine nitrilotriacetate, hexametaphosphate, pyrophosphate, and metaphosphate).

Examples of the preservative and the antifungal agent include sodium benzoate, sodium pentachlorophenolate, sodium 2-pyridinethiol-1-oxide, sodium sorbate, sodium dehydroacetate, PROXEL CRL, PROXEL BDN, PROXEL GXL, PROXEL XL-2, PROXEL IB, and PROXEL TN (trade names, all manufactured by LONZA KK.), and 4-chloro-3-methylphenol (such as PREVENTOL CMK manufactured by Bayer AG).

Examples of the rust inhibitor include benzotriazole, acidic sulfite, sodium thiosulfate, ammonium thioglycolic acid, diisopropylammonium nitrite, pentaerythritol tetranitrate, and dicyclohexylammonium nitrite. Among these, benzotriazole is particularly preferred.

### 1.2. Configuration of Apparatus

Hereinafter, an example of a recording apparatus including an ink jet head, an endless belt, a cleaning section, and a cleaning liquid will be described with reference to the drawings. The recording apparatus is an ink jet printer that records an image such as a character or a photograph on a fabric or a paper by discharging at least one of the above-mentioned ink compositions. The cleaning liquid will be described later.

### Recording Apparatus

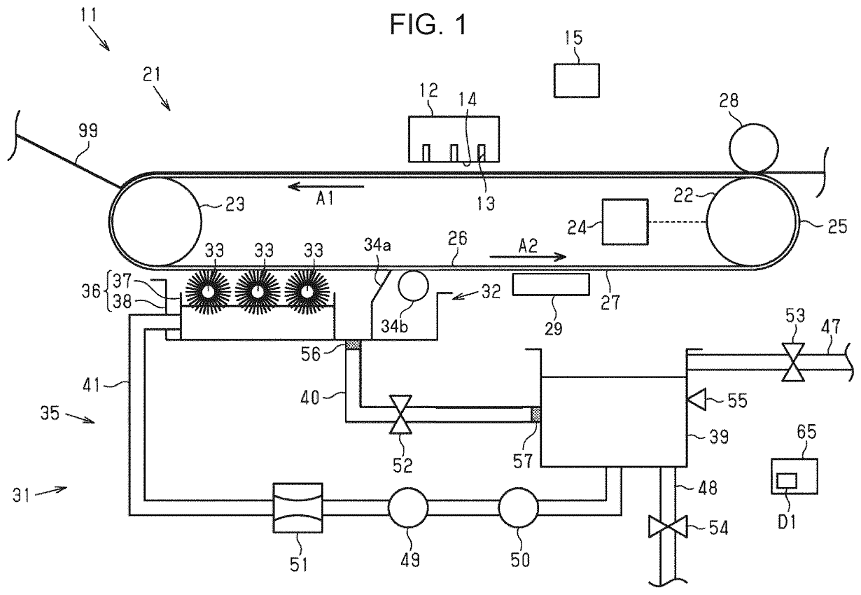

As shown in FIG. 1, the recording apparatus 11 includes a recording section 12. The recording section 12 is configured to eject the ink composition onto a fabric 99. As a result, the recording section 12 records an image on the fabric 99. The recording section 12 is an ink jet head. The recording section 12 has a nozzle surface 14 on which one or more nozzles 13 are open. The recording section 12 ejects the pigment ink from the nozzle 13. The recording section 12 may be a serial head that scans the fabric 99. The recording section 12 may be a line head that ejects the ink composition over the entire width of the fabric 99 at once.

The recording apparatus 11 includes a recording control section 15. The recording control section 15 controls the recording section 12. The recording control section 15 may control a transport section 21, a cleaning agent supply section, and a water supply section, which will be described later.

The recording control section 15 may be configured with one or more processors that execute various processes according to a computer program. The recording control section 15 may be configured with one or more dedicated hardware circuits such as an application-specific integrated circuit that executes at least a part of various processes. The recording control section 15 may be configured with a circuit including a combination of a processor and a hardware circuit. The processor includes a CPU and a memory such as RAM and ROM. The memory stores program codes or instructions configured to cause the CPU to execute processes. The memory, that is, a computer-readable medium includes any readable media that can be accessed by a general purpose or dedicated computer.

The recording apparatus 11 includes the transport section 21. The transport section 21 is configured to transport the fabric 99. In the process of transporting the fabric 99 by the transport section 21, the ink composition is ejected from the recording section 12 to the fabric 99.

The transport section 21 is configured to transport the fabric 99 in a transport direction A1. The transport section 21 has a plurality of transport rollers. In the example, the transport section 21 has a first transport roller 22 and a second transport roller 23. The first transport roller 22 is located upstream of the recording section 12 in the transport direction A1. The second transport roller 23 is located downstream of the recording section 12 in the transport direction A1.

The transport section 21 has a drive source 24. The drive source 24 is, for example, a motor. The drive source 24 is coupled to at least one of the plurality of transport rollers. In the example, the drive source 24 is coupled to the first transport roller 22. The first transport roller 22 is rotated by the drive source 24.

The transport section 21 has an endless belt 25. The endless belt 25 is wound around the plurality of transport rollers. In the example, the endless belt 25 is wound around the first transport roller 22 and the second transport roller 23. The endless belt 25 rotates along the first transport roller 22 and the second transport roller 23 by the drive source 24 rotating the first transport roller 22. In FIG. 1, the endless belt 25 rotates counterclockwise. As a result, the endless belt 25 transports the fabric 99. The endless belt 25 supports the fabric 99 on which an image is recorded by the recording section 12.

The endless belt 25 includes a portion that moves in the transport direction A1 and a portion that moves in an opposite direction A2 opposite to the transport direction A1. The endless belt 25 transports the fabric 99 by a portion moving in the transport direction A1. The portion moving in the opposite direction A2 is cleaned by a cleaning mechanism 31 described later.

The endless belt 25 has an inner peripheral surface 26 and an outer peripheral surface 27. The inner peripheral surface 26 is a surface that comes into contact with the plurality of transport rollers. In the example, the inner peripheral surface 26 is in contact with the first transport roller 22 and the second transport roller 23. The outer peripheral surface 27 is a surface that comes into contact with the fabric 99. Therefore, the outer peripheral surface 27 is a surface that supports the fabric 99. The outer peripheral surface 27 faces the nozzle surface 14. The endless belt 25 places and transports the fabric 99.

The endless belt 25 is configured to be adhered to the fabric 99. The endless belt 25 has a pressure sensitive adhesive layer on the surface. Specifically, the fabric 99 is adhered to the outer peripheral surface 27. As a result, the fabric 99 is transported in a stable posture. The endless belt 25 has a pressure sensitive adhesive layer in which an adhesive is applied to the outer peripheral surface. The adhesive is applied to the outer peripheral surface 27. In this case, the fabric 99 is adhered to the pressure sensitive layer of the outer peripheral surface 27 by the adhesive. The fabric 99 may be adhered to the outer peripheral surface 27 not only by the adhesive but also by, for example, suction force, electrostatic force, intermolecular force, or the like. The fabric 99 is peeled off from the outer peripheral surface 27 by being pulled by, for example, another apparatus after an image is recorded by the recording section 12. The transport section 21 may have a peeling section that peels off the fabric 99 from the outer peripheral surface 27. In this case, the peeling section is, for example, a roller around which the fabric 99 is wound.

The transport section 21 may have a pressing section 28. The pressing section 28 is configured to press the fabric 99 against the endless belt 25. In the example, the pressing section 28 is a pressure roller. The pressure roller pushes the fabric 99 against the endless belt 25 so that the fabric 99 is adhered to the outer peripheral surface 27. In other words, the pressure roller bonds the transport section 21 and the fabric 99 to each other. The pressing force of the pressure roller may be variable. When the pressing force of the pressure roller is adjusted, the adhesive force of the fabric 99 to the endless belt 25 can be easily adjusted.

In the endless belt 25, the ink composition may adhere to the outer peripheral surface 27 as the recording section 12 records an image on the fabric 99. When the endless belt 25 continues to transport the fabric 99 in a state where the ink composition is adhered to the outer peripheral surface 27, the fabric 99 may be soiled.

The recording apparatus 11 includes the cleaning mechanism 31. The cleaning mechanism 31 is configured to clean the endless belt 25 with the cleaning liquid. Specifically, the cleaning mechanism 31 cleans the outer peripheral surface 27 with the cleaning liquid. The cleaning mechanism 31 removes the ink composition adhering to the outer peripheral surface 27 by the cleaning liquid. The ink composition is easily removed from the endless belt 25 by the cleaning liquid. The cleaning liquid will be described later.

### Cleaning Mechanism

The cleaning mechanism 31 has a cleaning section 32. The cleaning section 32 cleans the endless belt 25 with the cleaning liquid. The cleaning section 32 cleans the endless belt 25 by coming into contact with the endless belt 25. Specifically, the cleaning section 32 comes into contact with the outer peripheral surface 27 on which the pressure sensitive adhesive layer is formed. The cleaning section 32 comes into contact with a portion of the endless belt 25 located in the opposite direction A2. That is, the cleaning section 32 comes into contact with the endless belt 25 after the fabric 99 is peeled off.

The cleaning section 32 includes a cleaning tank 36 that stores a cleaning liquid, and an abrading member that rubs the pressure sensitive adhesive layer in the cleaning tank 36. The cleaning section 32 has one or more cleaning rollers 33. In the example, the cleaning section 32 has three cleaning rollers 33. The cleaning roller 33 is an example of an abrading member. The cleaning roller 33 comes into contact with the endless belt 25 while rotating. The cleaning roller 33 may be rotated in a driven manner with respect to the endless belt 25. That is, the cleaning roller 33 may be rotated in a driven manner clockwise in FIG. 1. The cleaning roller 33 may be driven to rotate to resist the rotation of the endless belt 25. That is, the cleaning roller 33 may rotate counterclockwise in FIG. 1. In this case, the contact resistance between the cleaning roller 33 and the endless belt 25 increases, and thus the ink composition is easily removed from the endless belt 25.

The cleaning roller 33 comes into contact with the endless belt 25 in a state of being wet with the cleaning liquid. As a result, the endless belt 25 is wet with the cleaning liquid, thus the ink composition is easily removed from the endless belt 25. The cleaning roller 33 is, for example, a brush roller. The cleaning roller 33 may be a sponge roller.

The cleaning section 32 has one or more cleaning blades 34a. In the example, the cleaning section 32 has one cleaning blade 34a. The cleaning blade 34a is an example of a blade member. The cleaning blade 34a comes into contact with the endless belt 25 wet with the cleaning liquid. The cleaning blade 34a comes into contact with the outer peripheral surface 27 wet with the cleaning liquid. The cleaning blade 34a scrapes off the ink composition, the dried product thereof, and more specifically, the resin and the pigment contained in the ink composition, together with the cleaning liquid adhering to the endless belt 25. The cleaning blade 34a comes into contact with the endless belt 25 after the cleaning roller 33 comes into contact with the endless belt 25. Therefore, the cleaning blade 34a is located in the opposite direction A2 relative to the cleaning roller 33.

The cleaning section 32 includes one or more water squeezing rollers 34b. In the example, the cleaning section 32 has one water squeezing roller 34b. The water squeezing roller 34b comes into contact with the endless belt 25 wet with the cleaning liquid. The water squeezing roller 34b comes into contact with the outer peripheral surface 27 wet with the cleaning liquid. The water squeezing roller 34b wipes off the ink composition together with the cleaning liquid adhering to the endless belt 25. The water squeezing roller 34b comes into contact with the endless belt 25 after the cleaning roller 33 comes into contact with the endless belt 25. Therefore, the water squeezing roller 34b is located in the opposite direction A2 relative to the cleaning roller 33. The positional relationship between the water squeezing roller 34b and the cleaning blade 34a is not particularly limited.

The cleaning mechanism 31 includes a storage section 35. The storage section 35 is configured to store the cleaning liquid. The storage section 35 holds the cleaning section 32. The cleaning section 32 cleans the endless belt 25 by using the cleaning liquid stored in the storage section 35. The cleaning liquid stored in the storage section 35 is gradually contaminated as the cleaning section 32 cleans the endless belt 25. Therefore, the cleaning mechanism 31 may be configured to appropriately replace the cleaning liquid stored in the storage section 35.

The storage section 35 has a cleaning tank 36. The cleaning tank 36 is a tank that stores a cleaning liquid used by the cleaning section 32. The cleaning tank 36 is located to face the outer peripheral surface 27. The cleaning tank 36 holds the cleaning section 32.

The cleaning tank 36 has an immersion tank 37. The immersion tank 37 is a tank that stores a predetermined amount of cleaning liquid. The immersion tank 37 holds the cleaning roller 33. The immersion tank 37 holds the cleaning roller 33 such that the cleaning roller 33 is immersed in the stored cleaning liquid. As the cleaning roller 33 cleans the endless belt 25, the ink composition flows into the immersion tank 37.

The cleaning tank 36 has a support tank 38. The support tank 38 supports the immersion tank 37. Specifically, the support tank 38 accommodates the immersion tank 37. The support tank 38 receives the cleaning liquid overflowing from the immersion tank 37.

The support tank 38 supports the cleaning blade 34a and the water squeezing roller 34b. The support tank 38 receives the cleaning liquid flowing down along the cleaning blade 34a and the water squeezing roller 34b. As the cleaning blade 34a cleans the endless belt 25, the ink composition, the dried product thereof, the fiber dust, and the like flow into the support tank 38.

The storage section 35 has an accommodation tank 39. The accommodation tank 39 is a tank coupled to the cleaning tank 36. The accommodation tank 39 stores the cleaning liquid after the cleaning section 32 is used and the cleaning liquid before the cleaning section 32 is used.

The storage section 35 has a plurality of coupling flow paths. In the example, the storage section 35 has a first coupling flow path 40 and a second coupling flow path 41. The coupling flow path is a flow path coupled to the cleaning tank 36 and the accommodation tank 39. Specifically, the first coupling flow path 40 is coupled to the support tank 38 and the accommodation tank 39. The second coupling flow path 41 is coupled to the immersion tank 37 and the accommodation tank 39. The cleaning liquid flows from the cleaning tank 36 to the accommodation tank 39 through the first coupling flow path 40. The cleaning liquid flows from the accommodation tank 39 to the cleaning tank 36 through the second coupling flow path 41. As described above, in the storage section 35, the cleaning liquid circulates between the cleaning tank 36 and the accommodation tank 39. As a result, the concentration of the cleaning liquid tends to be uniform.

As illustrated in FIG. 1, the cleaning mechanism 31 includes a supply flow path 47. The supply flow path 47 is a flow path to which the cleaning liquid is supplied. A new cleaning liquid is supplied to the cleaning mechanism 31 through the supply flow path 47. The supply flow path 47 is coupled to the storage section 35. In the example, the supply flow path 47 is coupled to the accommodation tank 39. The supply flow path 47 is coupled to, for example, a water supply. When the cleaning liquid in the storage section 35 is reduced due to the evaporation of the cleaning liquid, the discharge of the cleaning liquid, or the like, the cleaning liquid is supplied from the supply flow path 47 to the storage section 35.

Although not illustrated, the cleaning tank 36 may include a cleaning agent supply section that supplies a cleaning agent to the cleaning tank 36 through the supply flow path 47, and a water supply section that supplies water to the cleaning tank 36. Further, the cleaning tank 36 may include a control section that controls the supply amount of the cleaning agent supplied from the cleaning agent supply section, for example, a polyoxyalkylene alkyl ether compound. Further, the cleaning tank 36 may include a control section that controls a supply amount of the water supplied from the water supply section.

In this way, the supply amount of the cleaning liquid and the water to the cleaning tank 36 can be controlled, and the concentration of the cleaning agent in the cleaning liquid can be varied. As a result, the degree of cleaning of the endless belt 25 can be adjusted, and the adhesive force of the pressure sensitive adhesive layer of the outer peripheral surface 27 of the endless belt 25 can be adjusted. In addition, as a result, the adhesion and the peeling property of a wider variety of fabrics can be improved. In the case of a fabric having high adhesion (for example, a plain weave untwisted yarn fabric), the degree of cleaning is suppressed and the adhesive force is not too strong so that the peeling property can be also improved. For a fabric having low adhesion (for example, a fabric made of a strong twisted yarn), the adhesion can be improved by increasing the degree of cleaning.

The cleaning mechanism 31 includes a discharge flow path 48. The discharge flow path 48 is a flow path through which the cleaning liquid is discharged. The cleaning liquid is discharged from the cleaning mechanism 31 through the discharge flow path 48. In the example, the discharge flow path 48 is coupled to the accommodation tank 39. The discharge flow path 48 is coupled to, for example, a processing apparatus that processes the waste liquid, a waste liquid tank that stores the waste liquid, or the like. When the cleaning liquid is contaminated with the ink composition, the cleaning liquid is discharged from the storage section 35 through the discharge flow path 48.

The cleaning mechanism 31 includes a pump 49. The pump 49 circulates the cleaning liquid in the storage section 35. The pump 49 circulates the cleaning liquid between the cleaning tank 36 and the accommodation tank 39 through the first coupling flow path 40 and the second coupling flow path 41. In the example, the pump 49 is located in the second coupling flow path 41. The pump 49 may be located in the first coupling flow path 40.

The cleaning mechanism 31 includes a flowmeter 50. The flowmeter 50 measures the flow rate of the cleaning liquid flowing in the storage section 35. The flowmeter 50 measures the flow rate of the cleaning liquid circulating between the cleaning tank 36 and the accommodation tank 39. The cleaning mechanism 31 controls the pump 49 based on the measurement result of the flowmeter 50. In the example, the flowmeter 50 is located in the second coupling flow path 41. Specifically, the flowmeter 50 is located between the pump 49 and the accommodation tank 39 in the second coupling flow path 41. The flowmeter 50 may be located in the first coupling flow path 40.

The cleaning mechanism 31 includes a constant flow rate valve 51. The constant flow rate valve 51 is configured to maintain the flow rate of the cleaning liquid flowing in the storage section 35 constant. The constant flow rate valve 51 is a so-called throttle valve. The constant flow rate valve 51 maintains the flow rate of the cleaning liquid circulating between the cleaning tank 36 and the accommodation tank 39 constant. In the example, the constant flow rate valve 51 is located in the second coupling flow path 41. Specifically, the constant flow rate valve 51 is located between the pump 49 and the cleaning tank 36 in the second coupling flow path 41. The constant flow rate valve 51 may be located in the first coupling flow path 40.

The cleaning mechanism 31 has one or more on-off valves. In the example, the cleaning mechanism 31 includes a first on-off valve 52, a second on-off valve 53, and a third on-off valve 54. The on-off valve is, for example, a solenoid valve. The first on-off valve 52 is located in the first coupling flow path 40. When the first on-off valve 52 is opened, the cleaning liquid can flow from the cleaning tank 36 to the accommodation tank 39. The second on-off valve 53 is located in the supply flow path 47. When the second on-off valve 53 is opened, the cleaning liquid is supplied to the storage section 35. The third on-off valve 54 is located in the discharge flow path 48. When the third on-off valve 54 is opened, the cleaning liquid is discharged from the storage section 35.

The cleaning mechanism 31 may include a liquid amount sensor 55. The liquid amount sensor 55 is a sensor that measures the amount of cleaning liquid stored in the storage section 35. In the example, the liquid amount sensor 55 measures the amount of cleaning liquid accommodated in the accommodation tank 39. The cleaning mechanism 31 can maintain the amount of cleaning liquid stored in the storage section 35 at a constant amount by the liquid amount sensor 55. For example, when the amount of the cleaning liquid stored in the accommodation tank 39 is large, the cleaning mechanism 31 discharges the cleaning liquid through the discharge flow path 48. When the amount of the cleaning liquid stored in the accommodation tank 39 is small, the cleaning mechanism 31 supplies the cleaning liquid through the supply flow path 47.

The cleaning mechanism 31 may include one or more filters as a filtering section that filters the cleaning liquid in the cleaning tank 36. The cleaning mechanism 31 includes a cleaning filter 56 and an accommodation filter 57. The filter collects dust, fluff, and the like in the cleaning liquid. The cleaning filter 56 is attached to the first coupling flow path 40. Specifically, the cleaning filter 56 is located at the end portion of the first coupling flow path 40 coupled to the cleaning tank 36. The cleaning filter 56 collects foreign matter from the cleaning liquid flowing from the cleaning tank 36 to the accommodation tank 39. The accommodation filter 57 is attached to the first coupling flow path 40. Specifically, the accommodation filter 57 is located at the end portion of the first coupling flow path 40 coupled to the accommodation tank 39. The accommodation filter 57 captures foreign matter from the cleaning liquid flowing from the cleaning tank 36 to the accommodation tank 39. Since the solid component in the cleaning liquid and the re-dispersed solid component can be filtered by the filtering section, the contamination of the cleaning liquid can be suppressed. As a result, the adhesive force of the pressure sensitive adhesive layer can be more easily maintained for a longer period of time. Further, the maintenance frequency of replacing the cleaning liquid stored in the cleaning tank 36 can be suppressed.

The filter can employ one or more selected from an activated carbon filter and a reverse osmosis membrane filter. In this way, the solid component in the cleaning liquid and the re-dispersed solid component can be easily removed by the filtering section, and the cleaning liquid can be easily kept clean.

The recording apparatus 11 includes a drying section 29 that dries the endless belt 25 cleaned by the cleaning section 32. As the drying section 29, one or more of a water absorbing mechanism that absorbs the liquid or the like remaining on the endless belt 25, a blowing mechanism that sends air to the endless belt 25, and a heating mechanism that heats the endless belt can be used. By including the drying section 29, the influence of the cleaning liquid on the adhesive force when the endless belt 25 adheres to the fabric 99 can be further reduced.

### 1.3. Cleaning Liquid

The cleaning liquid contains water and a cleaning agent containing a polyoxyalkylene alkyl ether compound.

### 1.3.1. Water

The cleaning liquid contains water. Regarding water, the above-mentioned ink composition and the content are the same, and thus the description thereof will be omitted.

### 1.3.2. Polyoxyalkylene Alkyl Ether Compound

The cleaning liquid according to the present embodiment contains a polyoxyalkylene alkyl ether compound. When the cleaning liquid contains the polyoxyalkylene alkyl ether compound, the polyoxyalkylene alkyl ether compound can suppress the re-adhesion of the solid component contained in the ink composition layer detached from the endless belt to the endless belt.

The polyoxyalkylene alkyl ether compound is not particularly limited and examples thereof include a compound represented by Formula (P). By using such a polyoxyalkylene alkyl ether compound, there is a tendency to more effectively reduce the re-adhesion of solid components and oily components to the endless belt, as well as to improve the storage stability of the cleaning liquid.

R⁶O(C₂H₄O)_{w}(C₃H₆O)ₓ(C₂H₄O)_{y}(C₃H₆O)_{z}H . . . (P)

In the above Formula (P), R⁶ represents an alkyl group having 1 to 20 carbon atoms, preferably an alkyl group having 5 to 15 carbon atoms, and more preferably an alkyl group having 10 to 15 carbon atoms. Also, w is a value from 1 to 20, and x, y, and z are independent values of 0 or 1 to 20. Further, w, x, y, and z satisfy 5≤w+x+y+z≤30, and preferably satisfy 5≤w+x+y+z≤25.

The polyoxyalkylene alkyl ether compound is not particularly limited, and specific examples thereof include C₁₂H₂₅O(C₂H₄O)₆(C₃H₆O)₂(C₂H₄O)₆(C₃H₆O)₈H, C₁₃H₂₇O(C₂H₄O)₆(C₃H₆O)₂(C₂H₄O)₆(C₃H₆O)₈H, C₁₂H₂₅O(C₂H₄O)_{w}(C₃H₆O)ₓ(C₂H₄O)_{y}(C₃H₆O)_{z}H (here, w+y=15, x+z=4), C₁₃H₂₇O(C₂H₄O)_{w}(C₃H₆O)ₓ(C₂H₄O)_{y}(C₃H₆O)_{z}H (here, w+y=15, x+z=4), C₁₂H₂₅O(C₂H₄O)₈(C₃H₆O)₂(C₂H₄O)₆H, C₁₃H₂₇O(C₂H₄O)₈(C₃H₆O)₂(C₂H₄O)₆H, C₁₂H₂₅O(C₂H₄O)₁₂(C₃H₆O)₂(C₂H₄O)₁₂H, C₁₃H₂₇O(C₂H₄O)₁₂(C₃H₆O)₂(C₂H₄O)₁₂H, CH₃(CH₂)₉(CH₃)CHO(C₂H₄O)₇(C₃H₆O)_{4.5}H, CH₃(CH₂)₁₁(CH₃)CHO(C₂H₄O)₇(C₃H₆O)_{4.5}H, CH₃(CH₂)₉(CH₃)CHO(C₂H₄O)₅(C₃H₆O)_{3.5}H, CH₃(CH₂)₁₁(CH₃)CHO(C₂H₄O)₅(C₃H₆O)_{3.5}H, C₁₄H₂₉O(C₂H₄O)₁₄(C₃H₆O)₂H, C₁₁H₂₃O(C₂H₄O)₈H, C₁₀H₂₁O(C₂H₄O)₁₁H, and C₁₂H₂₅O(C₂H₄O)₁₅H. Among these polyoxyalkylene alkyl ether compounds, polyethylene glycol mono-2-ethylhexyl ether is more preferable. As a result, the solid component of the layer of the ink composition adhered to the pressure sensitive adhesive layer of the endless belt is more easily swollen, and thus the adhered solid component is more easily detached.

The commercially available polyoxyalkylene alkyl ether compound is not particularly limited, and specific examples thereof include Neugen DL-0415, Neugen ET-116B, Neugen ET-106A, Neugen DH-0300, Neugen YX-400, Neugen EA-160 (all manufactured by DKS Co., Ltd.), Emulgen 1108 (trade name by Kao Corporation), and Newcol 1006 (manufactured by Nippon Nyukazai Co., Ltd.).

The polyoxyalkylene alkyl ether compound may be used alone or in combination of two or more.

The total content of the polyoxyalkylene alkyl ether compound in the cleaning liquid is preferably 0.5% by mass or more and 80% by mass or less, more preferably 1% by mass or more and 50% by mass or less, further preferably 1.5% by mass or more and 30% by mass or less, still further preferably 3% by mass or more and 20% by mass or less, and especially preferably 4% by mass or more and 10% by mass or less, relative to the total amount of the cleaning liquid.

In addition, the content of the polyoxyalkylene alkyl ether compound relative to the content of the glycol ether compound described later is preferably 0.1 to 5 by mass ratio, more preferably 0.1 to 3, and even more preferably 0.3 to 3. By having a relatively high content of the polyoxyalkylene alkyl ether compound, the cleaning effect can be further optimized.

### 1.3.3. Other Compounds

### (1) Glycol Ether Compound

The cleaning liquid may contain a glycol ether compound. When the cleaning liquid contains a glycol ether compound, the solid component and the oily component contained in the ink composition layer dried by adhering the ink composition to the endless belt can be swollen and/or dissolved, and thus the component can be easily detached from the endless belt. In addition, the cleaning liquid is more likely to penetrate between the pressure sensitive adhesive layer of the endless belt and the layer of the adhered ink composition, and the solid component of the layer of the ink composition is more likely to be swollen so that the adhered solid component is more likely to be detached.

The glycol ether compound is not particularly limited, but examples thereof include ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, triethylene glycol monobutyl ether, 1-methyl-1-methoxybutanol, propylene glycol monomethyl ether, propylene glycol monoethyl ether, propylene glycol monopropyl ether, propylene glycol monomethyl ether, dipropylene glycol monomethyl ether, dipropylene glycol monoethyl ether, dipropylene glycol monopropyl ether, propylene glycol monobutyl ether, dipropylene glycol monobutyl ether, 3-methoxy-3-methyl-1-butanol, ethylene glycol dimethyl ether, ethylene glycol diethyl ether, ethylene glycol dibutyl ether, diethylene glycol dimethyl ether, and diethylene glycol diethyl ether.

The glycol ether compound contained in the cleaning liquid is preferably selected from those exemplified above, specifically a compound having a surface tension of 40 mN/m or less at 25 °C. In this way, the surface tension of the cleaning liquid at 25 °C can be easily adjusted to 40 mN/m or less. In addition, the surface tension of the glycol ether compound contained in the cleaning liquid at 25 °C is more preferably 38 mN/m or less, even more preferably 35 mN/m or less, and particularly preferably 33 mN/m or less. The lower limit of the surface tension of the glycol ether compound contained in the cleaning liquid at 25 °C is not particularly limited, but is preferably 10 mN/m or more, and more preferably 15 mN/m or more.

The surface tension measurement can be performed by using an automatic surface tensiometer CBVP-Z (manufactured by Kyowa Interface Science Co., Ltd.) to measure the surface tension when wetting a platinum plate with the glycol ether compound under 25 °C environmental conditions.

Further, as the glycol ether compound contained in the cleaning liquid, when selecting a glycol ether compound having a surface tension of 40 mN/m or less at 25 °C, it is more preferable to select one or more from triethylene glycol monobutyl ether and 3-methoxy-3-methylbutanol. As a result, the glycol ether compound penetrates between the fabric transport member and the adhered ink jet composition layer, causing the solid components of the ink jet composition layer to swell, thus making it easier for the solid components to detach. In addition, when using 3-methoxy-3-methylbutanol, the odor of the cleaning liquid can be further reduced.

The total content of the glycol ether compound contained in the cleaning liquid is preferably 1% by mass or more and 50% by mass or less, more preferably 2% by mass or more and 40% by mass or less, further preferably 3% by mass or more and 35% by mass or less, still further preferably 6% by mass or more and 30% by mass or less, and especially preferably 10% by mass or more and 20% by mass or less, relative to the total amount of the cleaning liquid.

### (2) Antifoaming Agent

The cleaning liquid may further contain an antifoaming agent. Since the cleaning liquid is likely to foam due to the operation of the abrading member, when the cleaning liquid contains an antifoaming agent, the foaming of the cleaning liquid can be further suppressed.

The antifoaming agent is not particularly limited and examples thereof include a silicone-based antifoaming agent, a polyether-based antifoaming agent, a fatty acid ester-based antifoaming agent, and an acetylene glycol-based antifoaming agent. Examples of a commercially available antifoaming agent include BYK-011, BYK-012, BYK-017, BYK-018, BYK-019, BYK-020, BYK-021, BYK-022, BYK-023, BYK-024, BYK-025, BYK-028, BYK-038, BYK-044, BYK-080A, BYK-094, BYK-1610, BYK-1615, BYK-1650, BYK-1730, BYK-1770 (manufactured by BYK Japan KK.), Surfynol DF37, DF110D, DF58, DF75, DF220, MD-20, and Envirogem AD01 (manufactured by Evonik Industries). The antifoaming agent may be used alone or in combination of two or more. It is preferable to use a silicone-based antifoaming agent.

When the cleaning liquid contains an antifoaming agent, the content of the antifoaming agent is not particularly limited, but may be, for example, 0.01% by mass or more and 1.0% by mass or less relative to the total amount of the cleaning liquid, preferably, 0.05% by mass or more and 0.5% by mass or less, and more preferably 0.1% by mass or more and 0.2% by mass or less. With such a content, it is easy to suppress the antifoaming agent itself from adhering to the fabric transport member while suitably suppressing the foaming of the cleaning liquid, and thus it is easy to suppress the adhesion of the glue layer (pressure sensitive adhesive layer) from being lowered.

### (3) Other Components

The cleaning liquid may further contain the organic solvent, the surfactant, and other components described in the section of “1.1. Ink Composition” above. These components will be described in the description of the section “1.1. Ink Composition” by replacing “ink composition” with “cleaning liquid”.

### 1.3.4. Surface Tension

It is preferable that the surface tension of the cleaning liquid according to the present embodiment at 25 °C is 40 mN/m or less. The surface tension of the cleaning liquid at 25 °C is more preferably 38 mN/m or less, even more preferably 35 mN/m or less, and particularly preferably 33 mN/m or less. The lower limit of the surface tension of the cleaning liquid at 25 °C is not particularly limited, but is preferably 10 mN/m or more, and more preferably 15 mN/m or more. In this way, the cleaning liquid is more easily permeated between the pressure sensitive adhesive layer of the endless belt and the layer of the adhered ink composition, thus the adhered solid component is more easily detached.

The surface tension of the cleaning liquid can be adjusted by selecting and/or blending the type and amount of polyoxyalkylene alkyl ether compound, glycol ether compound, and the like, the water content, and the selection and addition amount of other components.

The surface tension can be measured by confirming the surface tension when a platinum plate is wetted with the cleaning liquid under a 25 °C environment using an automatic surface tensiometer CBVP-Z (manufactured by Kyowa Interface Science Co., Ltd.).

### 1.4. Effects

According to the ink jet textile printing recording apparatus of the present embodiment, each time the pressure sensitive adhesive layer on the surface of the endless belt passes through the cleaning section, the dirt (color material derived from the ink composition, fixing material, various functional materials, and lint derived from the fabric) adhering to and fixed to the pressure sensitive adhesive layer is scraped off and peeled by being rubbed by the abrading member. As a result, the contamination of the cleaning liquid stored in the cleaning tank proceeds gradually, and the dirt is easily readhered to the pressure sensitive adhesive layer. However, according to the ink jet textile printing recording apparatus of the present embodiment, since the cleaning liquid contains the polyoxyalkylene alkyl ether compound, the detachment of the dirt derived from the ink composition from the pressure sensitive adhesive layer is promoted, the solid component that is detached is dissolved/re-dispersed in water, and the readhesion of the solid component to the pressure sensitive adhesive layer can be suppressed. As a result, the contamination of the endless belt can be suppressed during the continuous textile printing operation.

Further, according to the ink jet textile printing recording apparatus of the present embodiment, since the cleaning liquid contains the polyoxyalkylene alkyl ether compound, damage to the endless belt or the pressure sensitive adhesive layer (peeling of the pressure sensitive adhesive layer or the like) can be suppressed. As a result, the transportability (adhesive force of the pressure sensitive adhesive layer) of the endless belt can be maintained in good condition, and the uneven density at the time of image formation can be suppressed.

### 2. Ink Jet Textile Printing Recording Method

An ink jet textile printing recording method according to the present embodiment includes ejecting an ink composition from an ink jet head and causing the ink composition to adhere to a fabric which is a recording medium, placing and transporting the fabric on an endless belt, and cleaning the endless belt, in which the endless belt has a pressure sensitive adhesive layer on a surface thereof, a cleaning section includes a cleaning tank that stores a cleaning liquid, the cleaning section includes an abrading member that rubs the pressure sensitive adhesive layer within the cleaning tank, and the cleaning liquid contains water and a cleaning agent containing a polyoxyalkylene alkyl ether compound.

The ink jet textile printing recording method according to the present embodiment can be realized by the above-mentioned ink composition, ink jet textile printing recording apparatus, and cleaning liquid.

According to the ink jet textile printing recording method of the present embodiment, each time the pressure sensitive adhesive layer on the surface of the endless belt passes through the cleaning section, the dirt (color material derived from the ink composition, fixing material, various functional materials, and lint derived from the fabric) adhering to and fixed to the pressure sensitive adhesive layer is scraped off and peeled by being rubbed by the abrading member. As a result, the contamination of the cleaning liquid stored in the cleaning tank proceeds gradually, and the dirt is easily readhered to the pressure sensitive adhesive layer. However, according to the ink jet textile printing recording method of the present embodiment, since the cleaning liquid contains the polyoxyalkylene alkyl ether compound, the detachment of the dirt derived from the ink composition from the pressure sensitive adhesive layer is promoted, the solid component that is detached is dissolved/re-dispersed in water, and the readhesion of the solid component to the pressure sensitive adhesive layer can be suppressed. As a result, the contamination of the endless belt can be suppressed during the continuous textile printing operation.

Further, according to the ink jet textile printing recording method of the present embodiment, since the cleaning liquid contains the polyoxyalkylene alkyl ether compound, damage to the endless belt or the pressure sensitive adhesive layer (peeling of the pressure sensitive adhesive layer or the like) can be suppressed. As a result, the transportability (adhesive force of the pressure sensitive adhesive layer) of the endless belt can be maintained in good condition, and the uneven density at the time of image formation can be suppressed.

### 3. Examples and Comparative Examples

Hereinafter, the present disclosure will be specifically described with reference to Examples, and the present disclosure is not limited to these Examples. Hereinafter, “part” and “%” are based on mass unless otherwise specified. Unless otherwise specified, the evaluation was performed in an environment of a temperature of 25 °C and a relative humidity of 40.0%.

### 3.1. Preparation of Each Composition

### (1) Preparation of Cleaning Liquid

The cleaning liquid of each example was prepared with the compositions and the blending amounts shown in Tables 1 to 3. Each material was mixed according to the composition shown in the table and sufficiently stirred to obtain the cleaning liquid. The numerical values represent the active ingredient concentration, the unit of the values is % by mass, and the total is 100.0% by mass.

### (2) Preparation of Ink Composition

The ink compositions were prepared with the compositions and the blending amounts shown in Tables 4 to 6. The first ink shown in Table 4 is an ink composition corresponding to a reactive liquid containing a cationic acrylic resin as an aggregating agent. The second ink shown in Table 5 is a color ink composition containing polycarbonate-based polyurethane, which is a resin emulsion, as resin particles, and a pigment. The third ink shown in Table 6 is an ink composition corresponding to a softening liquid containing a cationic silicone oil emulsion containing organopolysiloxane as resin particles. Each material was mixed according to the composition shown in the table and sufficiently stirred to obtain the ink composition. The numerical values represent the solid component concentration, the unit of the values is % by mass, and the total is 100.0% by mass.

### (3) Ink Set

Table 7 shows the ink set of the ink composition used for the evaluation of the example and the comparative example.

The abbreviations and trade names shown in Tables 1 to 6 are supplemented with description.
Newcol 1006: Polyoxyalkylene alkyl ether (manufactured by Nippon Nyukazai Co., Ltd.)
BYK-028: antifoaming agent (manufactured by BYK Japan KK.)
OLFINE E1010 (acetylene glycol-based surfactant manufactured by Nissin Chemical Industry Co., Ltd.)

Anionic self-dispersing pigment: Manufactured as follows. 500 g of carbon black bulk powder prepared by a furnace method (primary particle diameter=18 nm, BET specific surface area=180 m²/g, DBP absorption amount=186 mL/ 100 g) was added to 3750 g of ion exchange water, and the temperature was raised to 45 °C while carrying out stirring with a dissolver. After that, 30,000 g of an aqueous solution of sodium hypochlorite (effective chlorine concentration=12%) was added dropwise over 3.5 hours at 45 °C while pulverizing with a sand mill using zirconia beads having a diameter of 0.8 mm. Subsequently, the pulverization with the sand mill was continued for a further 30 minutes to obtain a reactive liquid containing a self-dispersing type carbon black. The reactive liquid was filtered using 400 mesh wire net, and thus the zirconia beads and unreacted carbon black were separated from the reactive liquid. A 5% potassium hydroxide aqueous solution was added to the reactive liquid obtained through the separation to adjust the pH to 7.5. Desalination and purification were then carried out using an ultrafiltration membrane until the electrical conductivity of the liquid reached 1.5 mS/cm. Desalination and purification were then further carried out using an electrodialyzer until the electrical conductivity of the liquid reached 1.0 mS/cm. The liquid was concentrated until the concentration of the self-dispersing carbon black reached 17% by mass. The concentrate was subjected to centrifugal separation with a centrifugal separator to remove coarse particles, followed by filtration through a 0.6 μm filter. Ion exchange water was added to the obtained filtrate and diluted until the concentration of the self-dispersing carbon black reached 15% by mass, and dispersed to obtain a self-dispersing pigment dispersion.

An ink 3 in Table 6 was prepared as follows.

90 g of amino-modified silicone oil (KF-868, functional group equivalent: 8, 800 g/mol, manufactured by Shin-Etsu Chemical Co., Ltd.), 173.2 g of ion exchange water, 5.1 g of polyoxyethylene tridecyl ether (Newcol 1310, Nippon Nyukazai Co., Ltd.), 25.7 g of 1,2-hexanediol, and 6 g of lactic acid were placed in a beaker, and the contents of the beaker were stirred for 30 minutes at 50 °C at a rotation speed of 2000 rpm using a homomixer (HOMO MIXER MARK II Model 2.5, manufactured by PRIMIX Corporation), and left to stand for 30 minutes. Next, the content in the beaker was filtered through a 10 μm membrane filter to obtain 300 g of an emulsion in which oil particles containing amino-modified silicone oil were dispersed. Subsequently, ion exchange water and glycerin were added and stirred to prepare the ink 3.

Tables 1 to 3 show the surface tensions of the glycol ether compound, polyoxyalkylene alkyl ether compound, and water in the cleaning liquid individually, as well as the surface tension of the cleaning liquid. The surface tension was measured using the Wilhelmy method with a platinum plate in a 25 °C environment, using an automatic surface tensiometer CBVP-Z (manufactured by Kyowa Interface Science Co., Ltd.). In addition, triethanolamine was blended so that the pH of the cleaning liquid in each example was from 10 to 11. Further, Table 7 lists the evaluation results for color development, bleeding, yellowing, abrasion resistance (dry), abrasion resistance (wet), and texture (shear hardness G) for each ink set.

### 3.2. Evaluation Method

### 3.2.1. Belt Cleaning Test

A predetermined amount (60 L) of each cleaning liquid was charged into a cleaning tank including two brush members and a blade member (two squeegees and one soft squeegee), and the cleaning operation on the endless belt surface was continuously performed by synchronously driving the printing operation of the printer section and the brush member provided in the cleaning tank. An apparatus modified from Evo Tre 16 manufactured by Seiko Epson Corporation was used. The apparatus has a configuration as illustrated in FIG. 1.

With an ink set 1 and an ink set 2 listed in Tables 1 to 3, printing was performed on a recording medium (pretreated for pigment) under the conditions listed in Table 7 using a modified Evo Tre 16 (manufactured by Seiko Epson Corporation), and main scanning was performed a plurality of times on the same scanning area to form a 20 cm×5 cm solid pattern image (black pigment ink, duty 100%) on the fabric, which was the recording medium. Subsequently, a 5 cm fabric was transported in the sub-scanning direction, printing was performed again on the same scanning area, and a solid pattern image of 20 cm×10 cm was formed in the fabric as a medium to be recorded by two times of printing. The ink ejection amount was 30 g/m², and the resolution was 600×600 dpi.

The printing was continuously performed. Meanwhile, each example of the cleaning liquid was introduced into the cleaning unit of the apparatus, and the pressure sensitive adhesive layer was cleaned with the cleaning liquid through printing. As for the belt adhesive, ATR 1946 (adhesive, manufactured by ATR Corporation) 800 g and ATR 1947 (adhesive, manufactured by ATR Corporation) 800 g were mixed and prepared. The prepared belt adhesive was applied onto the belt according to the procedures in the user's manual to form a pressure sensitive adhesive layer.

Tables 1 to 3 show the surface tension values (mN/m) of the cleaning liquids of each example. The presence (Y) or absence (N) of each of the abrading member (cleaning brush), the filtering section (activated carbon filter), and the cleaning agent supply section/water supply section is described.

The fabric used was a highly adhesive fabric, “Cupra Twill” R10175, 100% cupra (Akahori Sangyo Co., Ltd.). However, only in Example 11, the type of fabric used was a non-adhesive fabric, “Tetre Twill” TR-3903, 65% Tetron/35% Rayon (Masuda Co., Ltd.).

### 3.2.2. Evaluation of Odor

A sensory evaluation of odor was conducted in the area within 1 meter around the cleaning operation. Specifically, as a sensory test by 10 evaluators, odor determination was carried out using the following 6-level scale, and the average value was used for determination. The results are shown in Tables 1 to 3.

### Odor Evaluation Score: Sensory Test

0: Odorless
1: Slightly perceptible odor
2: Perceptible as a faint odor (not unpleasant)
3: Perceptible as a moderate odor (slightly unpleasant)
4: Perceptible as a strong odor (unpleasant)
5: Intense odor (very unpleasant)

### Odor Determination Results

A: Average value less than 2 (odor is not bothersome)
B: Average value 2 or more and less than 3 (odor is perceived but acceptable)
C: Average value 3 or more (odor is strong odor and unpleasant)

### 3.2.3. Removal of Fluff and Dirt

The amount of lint and fluff present on the surface of the pressure sensitive adhesive layer of the endless belt was visually counted from a close-up photograph of the image, and the average value was calculated. The photographing location was selected from five areas divided in the belt width direction, and one location with the most severe contamination was selected from each of the five areas, and a close-up photograph of a 1 inch square area was captured. The number of lint and fluff present in a 1 inch square area was visually counted from the close-up photograph image, and the average value of five locations was taken. The evaluation criteria were as follows, and the evaluation results are shown in Tables 1 to 3.
A: No lint is present. Less than 1 bit of fluff is present on average (extremely good)
B: No lint is present. Less than 5 bits of fluff, 1 or more bits of fluff are present on average (good)
C: No lint present. 5 or more bits of fluff are present on average (slightly insufficient level)
D: 0.2 or more bits of lint are present on average. 5 or more bits of fluff are present on average (insufficient level)

### 3.2.4. Removal of Pigment and Resin Stain

The adhesive force of the pressure sensitive adhesive layer was measured using a push-pull gauge (FPG-1 manufactured by Nidec Drive Technology Corporation). The measurement location was selected from three areas divided in the belt width direction, and one location with the most severe contamination was selected from each of the three areas, and adhesive force was measured at a total of three locations. The adhesive force was measured by attaching the following cotton fabric cut into strips (50×200 mm) according to the procedure in the user's manual, monitoring the tension when peeling the fabric off vertically upward, and calculating the average value at three locations. Cotton fabric: A. Ferrario Taffetas. 100% cotton (124-132 g/m²)

The evaluation criteria are as follows, and the results are shown in Tables 1 to 3.
A: Average adhesive force is 3 N/50 mm or more (extremely good)
B: Average adhesive force is 2 N/50 mm or more and less than 3 N/50 mm (good)
C: Average adhesive force is 1 N/50 mm or more and less than 2 N/50 mm (slightly insufficient level)
D: Average adhesive force is less than 1 N/50 mm (insufficient level)

### 3.2.5. Uneven Lifting Density

After the pressure sensitive adhesive layer was cleaned, a predetermined fabric (CM80 satin) was attached to the endless belt, and a continuous printing operation was executed again in accordance with the user's manual. It was confirmed that repeated printing operations gradually cause contaminants (adhered matter such as ink and fluff) to accumulate on the pressure sensitive adhesive layer on the endless belt, resulting in a decrease in adhesive force. In the section until the adhesive force decreased to 0.2 N/50 mm or less, it was confirmed whether or not fabric lifting occurred. The evaluation criteria are as follows, and the results are shown in the table.
A: No occurrence of fabric lifting (good)
B: Fabric lifting occurs only at the edges in the fabric width direction (outside the image area) (acceptable)
C: Fabric lifting occurs within the image area (insufficient)
D: The fabric is lifted in many places, making it difficult to fix the fabric to the endless belt (making fabric transport difficult)

When no fabric lifting occurred within the image area, uneven density was not observed in the image during image formation. When fabric lifting occurred within the image area, uneven density in the image was visually confirmed during image formation.

### 3.2.6. Others

The liquid level in the cleaning tank was visually inspected after the printing operation. In Example 6, foaming was confirmed in the cleaning tank. In the examples other than Example 6, foaming was not confirmed.

### 3.3. Evaluation of Ink Set

Using a modified Evo Tre 16 (manufactured by Seiko Epson Corporation), printing was performed on a 100% cotton white broadcloth (#4000, manufactured by Nisshinbo Industries Inc.) recording medium under the conditions described in Table 7. Main scanning was performed a plurality of times on the same scanning area to form a 20 cm×5 cm solid pattern image on the fabric, which is the recording medium. Subsequently, a 5 cm fabric was transported in the sub-scanning direction, printing was performed again on the same scanning area, and a solid pattern image of 20 cm×10 cm was formed in the fabric as a medium to be recorded by two times of printing.

After image formation, the printed textiles of each ink set were produced by starting a heating process at 160 °C for 3 minutes in an oven after drying the printed matter for 3 minutes. The “solid pattern image” means an image where dots are uniformly formed over the entire recording area (main scanning direction×sub-scanning direction: 20 cm×10 cm) so that the application amount of each ink reaches the numerical values listed in Table 7.

### Evaluation of Color Development (Black)

The black optical density (OD value, Status E) of a surface of a printed image on the printed matter obtained by the above-mentioned printing method was measured using a colorimeter (FD-7, manufactured by Konica Minolta Inc.), and was determined according to the following criteria.

### Determination Criteria

SS: OD value of 1.60 or more
S: OD value of 1.51 or more and less than 1.60
A: OD value of 1.46 or more and less than 1.51
B: OD value of 1.43 or more and less than 1.46
C: OD value of 1.35 or more and less than 1.43

### Evaluation of Bleeding

From the printing methods described above, printed textile samples were prepared by drying the printed textile samples after leaving the printed textile samples for 60 minutes following image formation, then beginning the heating process at 160 °C for 3 minutes in an oven. In addition, reference samples were prepared from the printed textiles at the point of drying after printing with the first ink (reactive liquid) and the second ink (ink composition). The boundary between the printed image area and the unprinted non-image area was observed, and the difference in length (mm) in the sub-scanning direction between the printed image left for 60 minutes and the reference printed image was determined according to the following criteria.

### Determination Criteria

S: The difference in length is 1 mm or less.
A: The difference in length is more than 1 mm and less than or equal to 3 mm.
B: The difference in length is more than 3 mm and less than or equal to 7 mm.
C: The difference in length is more than 7 mm and less than or equal to 12 mm.

### Evaluation of Yellowing

Among the printing methods described above, only the third ink (softening liquid) was recorded on the recording fabric at 30 g/m², and a printed fabric dried by the above method was prepared. The surface of the printed image was measured for L*, a*, and b* using a colorimeter (FD-7, manufactured by Konica Minolta Inc.) and was used as a sample. In addition, a cloth that was dried in an oven at 160 °C for 3 minutes without printing with a printer in the above-described method was prepared, L*, a*, and b* values were measured in the same manner, and the cloth was used as a reference. With respect to this reference, a color difference ΔE00 (ΔE2000) of the sample was calculated and determined by the following standards. Since the ink set 2 does not use the third ink, the color difference does not occur in the present evaluation.

### Determination Criteria

A: The color difference ΔE00 is less than or equal to 2.
B: The color difference ΔE 00 is more than 2 and less than or equal to 7.

### Evaluation of Abrasion Resistance (Dry)

For the printed textiles prepared by using the above-described printing method, the image of the printed textiles was rubbed 10 times with shirting (white cotton cloth) using a crock meter (FI-306, manufactured by Tester Sangyo Co., Ltd.) with a load of 9N. Thereafter, for the region contaminated with the ink of the rubbed shirting, the optical density (OD, Status E) of black of the printed image was measured using a colorimeter (FD-7, manufactured by Konica Minolta Inc.) and determined according to the following criteria.

### Determination Criteria

S: The OD of black is less than or equal to 0.15.
A: The OD of black is more than 0.15 and less than or equal to 0.19.
B: The OD of black is more than 0.19 and less than or equal to 0.23.
C: The OD of black is more than 0.23 and less than or equal to 0.33.

### Evaluation of Abrasion Resistance (Wet)

For the printed textiles prepared by using the above-described printing method, the image of the printed textiles was rubbed 10 times with shirting (white cotton cloth) wetted with water in an amount equal to the weight of the cloth using a crock meter (FI-306, manufactured by Tester Sangyo Co., Ltd.) with a load of 9N. Thereafter, for the region contaminated with the ink of the rubbed shirting, the optical density (OD, Status E) of black of the printed image was measured using a colorimeter (FD-7, manufactured by Konica Minolta Inc.) and determined according to the following criteria.

### Determination Criteria

S: The OD of black is less than or equal to 0.26.
A: The OD of black is more than 0.26 and less than or equal to 0.31.
B: The OD of black is more than 0.31 and less than or equal to 0.45.
C: The OD of black is more than 0.45.

### Evaluation of Texture (Shear Hardness G)

For the printed textile samples created using the printing method described above, the texture was evaluated by a sensory evaluation. Specifically, five arbitrary evaluators were asked to answer either “the texture is comparable to that of the original fabric” or “the printed fabric is stiff and the original texture of the fabric is compromised,” and the evaluation was performed according to the following criteria.

### Determination Criteria

A: Three or more evaluators responded that “the texture is comparable to the original texture of the fabric”.
B: Two or fewer evaluators responded that “the texture is comparable to the original texture of the fabric”.

### 3.4. Evaluation Results

From Tables 1 to 3, with the ink jet textile printing recording apparatus, which is provided with an ink composition, an ink jet head that ejects the ink composition onto a fabric which is a recording medium, an endless belt that has a pressure sensitive adhesive layer on a surface thereof and that places and transports the fabric, a cleaning tank that stores a cleaning liquid, a cleaning section that cleans the endless belt that has an abrading member that rubs the pressure sensitive adhesive layer in the cleaning tank, and a cleaning liquid, the cleaning liquid containing water and a cleaning agent that contains a polyoxyalkylene alkyl ether compound, it is found that the ink jet textile printing recording apparatus of each example can maintain good transportability of the endless belt (adhesive force of the pressure sensitive adhesive layer) and can suppress uneven density during image formation.

The present disclosure includes a configuration substantially the same as the configuration described in the embodiment, for example, a configuration having the same function, method, and result, or a configuration having the same purpose and effect. Further, the present disclosure includes configurations in which non-essential parts of the configuration described in the embodiments are replaced. In addition, the present disclosure includes configurations that achieve the same effects or configurations that can achieve the same objects as those of the configurations described in the embodiment. Further, the present disclosure includes configurations in which a known technology is added to the configurations described in the embodiments.

The following contents are derived from the above-described embodiments and modification examples.

An ink jet textile printing recording apparatus includes an ink composition, an ink jet head that ejects the ink composition onto a fabric which is a recording medium, an endless belt that places and transports the fabric, a cleaning section that cleans the endless belt, and a cleaning liquid, in which the endless belt has a pressure sensitive adhesive layer on a surface thereof, the cleaning section includes a cleaning tank that stores the cleaning liquid, and an abrading member that rubs the pressure sensitive adhesive layer within the cleaning tank, and the cleaning liquid contains water and a cleaning agent containing a polyoxyalkylene alkyl ether compound.

According to this ink jet textile printing recording apparatus, each time the pressure sensitive adhesive layer on the surface of the endless belt passes through the cleaning section, the dirt (color material derived from the ink composition, fixing material, various functional materials, and lint derived from the fabric) adhering to and fixed to the pressure sensitive adhesive layer is scraped off and released by being rubbed by the abrading member. As a result, the contamination of the cleaning liquid stored in the cleaning tank proceeds gradually, and the dirt is easily readhered to the pressure sensitive adhesive layer. However, according to this ink jet textile printing recording apparatus, since the cleaning liquid contains the polyoxyalkylene alkyl ether compound, the detachment of the dirt derived from the ink composition from the pressure sensitive adhesive layer is promoted, the solid component that is detached is dissolved/re-dispersed in water, and the readhesion of the solid component to the pressure sensitive adhesive layer can be suppressed. As a result, the contamination of the endless belt can be suppressed during the continuous textile printing operation.

Further, according to the ink jet textile printing recording apparatus, since the cleaning liquid contains the polyoxyalkylene alkyl ether compound, damage to the endless belt or the pressure sensitive adhesive layer (peeling of the pressure sensitive adhesive layer or the like) can be suppressed. As a result, the transportability (adhesive force of the pressure sensitive adhesive layer) of the endless belt can be maintained in good condition, and the uneven density at the time of image formation can be suppressed.

In the ink jet textile printing recording apparatus, a content of the polyoxyalkylene alkyl ether compound in the cleaning liquid may be 80% by mass or less relative to a total amount of the cleaning liquid.

According to this ink jet textile printing recording apparatus, the contamination of the endless belt can be further suppressed.

In the ink jet textile printing recording apparatus, the cleaning agent may contain a glycol ether compound.

According to this ink jet textile printing recording apparatus, the cleaning liquid is more likely to penetrate between the pressure sensitive adhesive layer of the endless belt and the layer of the adhered ink composition, and the solid component of the layer of the ink composition is more likely to be swollen so that the adhered solid component is more likely to be detached.

In the ink jet textile printing recording apparatus, the glycol ether compound may include a glycol ether compound having a surface tension of 40 mN/m or less at 25 °C.

According to this ink jet textile printing recording apparatus, since the cleaning liquid is more likely to permeate between the pressure sensitive adhesive layer of the endless belt and the layer of the adhered ink composition, the adhered solid component is more likely to be detached.

In the ink jet textile printing recording apparatus, the glycol ether compound having a surface tension of 40 mN/m or less may contain one or more selected from triethylene glycol monobutyl ether and 3-methoxy-3-methylbutanol.

According to this ink jet textile printing recording apparatus, since the odor of the cleaning liquid is less, and the cleaning liquid is more likely to permeate between the pressure sensitive adhesive layer of the endless belt and the layer of the adhered ink composition, the adhered solid component is more likely to be detached.

In the ink jet textile printing recording apparatus, a surface tension of the cleaning liquid at 25 °C may be 40 mN/m or less.

According to this ink jet textile printing recording apparatus, since the cleaning liquid is more likely to permeate between the pressure sensitive adhesive layer of the endless belt and the layer of the adhered ink composition, the adhered solid component is more likely to be detached.

In the ink jet textile printing recording apparatus, the polyoxyalkylene alkyl ether compound may be polyethylene glycol mono-2-ethylhexyl ether.

According to this ink jet textile printing recording apparatus, the solid component of the layer of the ink composition adhering to the pressure sensitive adhesive layer of the endless belt is more easily swelled, and thus the adhered solid component is more likely to be detached.

In the ink jet textile printing recording apparatus, the cleaning liquid may further contain an antifoaming agent.

According to this ink jet textile printing recording apparatus, since the cleaning liquid is likely to foam due to the operation of the abrading member, when the cleaning liquid contains an antifoaming agent, the foaming of the cleaning liquid can be suppressed.

In the ink jet textile printing recording apparatus, the cleaning section may have a filtering section that filters the cleaning liquid in the cleaning tank.

According to this ink jet textile printing recording apparatus, since the solid component in the cleaning liquid and the re-dispersed solid component can be filtered by the filtering section, the contamination of the cleaning liquid can be suppressed. As a result, the adhesive force of the pressure sensitive adhesive layer can be more easily maintained for a longer period of time. Further, the maintenance frequency of replacing the cleaning liquid stored in the cleaning tank can be suppressed.

In the ink jet textile printing recording apparatus, the filtering section may have one or more selected from an activated carbon filter and a reverse osmosis membrane filter.

According to this ink jet textile printing recording apparatus, the solid component in the cleaning liquid and the re-dispersed solid component can be easily removed by the filtering section, and the cleaning liquid can be easily kept clean.

In the ink jet textile printing recording apparatus, a cleaning agent supply section that supplies the cleaning agent to the cleaning tank, and a water supply section that supplies water to the cleaning tank may be further provided.

According to this ink jet textile printing recording apparatus, the supply amount of the cleaning liquid and the water to the cleaning tank can be controlled, and the density of the cleaning agent in the cleaning liquid can be varied. As a result, the degree of cleaning of the endless belt can be adjusted, and the adhesive force of the pressure sensitive adhesive layer of the endless belt can be adjusted. In addition, as a result, the adhesion and the peeling property of a wider variety of fabrics can be improved.

In the ink jet textile printing recording apparatus, a control section that controls a supply amount of the polyoxyalkylene alkyl ether compound supplied from the cleaning agent supply section may be further provided.

In the ink jet textile printing recording apparatus, a control section that controls a supply amount of the water supplied from the water supply section may be further provided.

In the ink jet textile printing recording apparatus, a pressure roller that presses together the transport section and the fabric may be further provided, and a pressing force of the pressure roller may be variable.

According to this ink jet textile printing recording apparatus, when the pressing force of the pressure roller can be adjusted, the adhesive force of the fabric to the endless belt is easily adjusted.

In the ink jet textile printing recording apparatus, the cleaning section may have a blade member that rubs the pressure sensitive adhesive layer.

According to this ink jet textile printing recording apparatus, the liquid adhering to the endless belt can be scraped off.

In the ink jet textile printing recording apparatus, a drying section that dries the endless belt cleaned by the cleaning section may be further provided, and the drying section may include one or more selected from a water absorbing mechanism, a blowing mechanism, and a heating mechanism.

According to this ink jet textile printing recording apparatus, the influence of the cleaning liquid on the adhesive force when the endless belt adheres to the fabric can be further reduced.

In the ink jet textile printing recording apparatus, the ink composition may be a colored ink composition containing a pigment.

When the ink composition contains a pigment, the solid component of the colored ink composition such as a resin and a pigment is relatively large. Therefore, the adhesive force of the pressure sensitive adhesive layer of the endless belt is more likely to decrease. However, according to the ink jet textile printing recording apparatus, the decrease in adhesive force can be reduced, and since the colored ink composition is a pigment ink, the cleaning step after the textile printing can be omitted or simplified.

In the ink jet textile printing recording apparatus, the ink composition may be a functional liquid containing organopolysiloxane as resin particles.

According to this ink jet textile printing recording apparatus, the texture and the color development of the printed textiles can be easily improved.

In the ink jet textile printing recording apparatus, the ink composition may be substantially free of colorants.

An ink jet textile printing recording method includes ejecting an ink composition from an ink jet head and causing the ink composition to adhere to a fabric which is a recording medium, placing and transporting the fabric on an endless belt, and cleaning the endless belt, in which the endless belt has a pressure sensitive adhesive layer on a surface thereof, a cleaning section includes a cleaning tank that stores a cleaning liquid, the cleaning section includes an abrading member that rubs the pressure sensitive adhesive layer within the cleaning tank, and the cleaning liquid contains water and a cleaning agent containing a polyoxyalkylene alkyl ether compound.

According to this ink jet textile printing recording method, each time the pressure sensitive adhesive layer on the surface of the endless belt passes through the cleaning section, the dirt (color material derived from the ink composition, fixing material, various functional materials, and lint derived from the fabric) adhering to and fixed to the pressure sensitive adhesive layer is scraped off and released by being rubbed by the abrading member. As a result, the contamination of the cleaning liquid stored in the cleaning tank proceeds gradually, and the dirt is easily readhered to the pressure sensitive adhesive layer. However, according to this ink jet textile printing recording method, since the cleaning liquid contains the polyoxyalkylene alkyl ether compound, the detachment of the dirt derived from the ink composition from the pressure sensitive adhesive layer is promoted, the solid component that is detached is dissolved/re-dispersed in water, and the readhesion of the solid component to the pressure sensitive adhesive layer can be suppressed. As a result, the contamination of the endless belt can be suppressed during the continuous textile printing operation.

Further, according to the ink jet textile printing recording method, since the cleaning liquid contains the polyoxyalkylene alkyl ether compound, damage to the endless belt or the pressure sensitive adhesive layer (peeling of the pressure sensitive adhesive layer or the like) can be suppressed. As a result, the transportability (adhesive force of the pressure sensitive adhesive layer) of the endless belt can be maintained in good condition, and the uneven density at the time of image formation can be suppressed.

What is claimed is:

1. An ink jet textile printing recording apparatus comprising:
an ink composition;
an ink jet head that ejects the ink composition onto a fabric which is a recording medium;
an endless belt that places and transports the fabric;
a cleaning section that cleans the endless belt; and
a cleaning liquid, wherein
the endless belt has a pressure sensitive adhesive layer on a surface thereof,
the cleaning section includes a cleaning tank that stores the cleaning liquid, and an abrading member that rubs the pressure sensitive adhesive layer within the cleaning tank, and
the cleaning liquid contains water and a cleaning agent containing a polyoxyalkylene alkyl ether compound.

2. The ink jet textile printing recording apparatus according to claim 1, wherein
a content of the polyoxyalkylene alkyl ether compound in the cleaning liquid is 80% by mass or less relative to a total amount of the cleaning liquid.

3. The ink jet textile printing recording apparatus according to claim 1, wherein
the cleaning agent contains a glycol ether compound.

4. The ink jet textile printing recording apparatus according to claim 3, wherein
the glycol ether compound includes a glycol ether compound having a surface tension of 40 mN/m or less at 25 °C.

5. The ink jet textile printing recording apparatus according to claim 4, wherein
the glycol ether compound having a surface tension of 40 mN/m or less contains one or more selected from triethylene glycol monobutyl ether and 3-methoxy-3-methylbutanol.

6. The ink jet textile printing recording apparatus according to claim 1, wherein
a surface tension of the cleaning liquid at 25 °C is 40 mN/m or less.

7. The ink jet textile printing recording apparatus according to claim 1, wherein
the polyoxyalkylene alkyl ether compound is polyethylene glycol mono-2-ethylhexyl ether.

8. The ink jet textile printing recording apparatus according to claim 1, wherein
the cleaning liquid further contains an antifoaming agent.

9. The ink jet textile printing recording apparatus according to claim 1, wherein
the cleaning section has a filtering section that filters the cleaning liquid in the cleaning tank.

10. The ink jet textile printing recording apparatus according to claim 9, wherein
the filtering section has one or more selected from an activated carbon filter and a reverse osmosis membrane filter.

11. The ink jet textile printing recording apparatus according to claim 1, further comprising:
a cleaning agent supply section that supplies the cleaning agent to the cleaning tank; and
a water supply section that supplies water to the cleaning tank.

12. The ink jet textile printing recording apparatus according to claim 11, further comprising:
a control section that controls a supply amount of the polyoxyalkylene alkyl ether compound supplied from the cleaning agent supply section.

13. The ink jet textile printing recording apparatus according to claim 11, further comprising:
a control section that controls a supply amount of the water supplied from the water supply section.

14. The ink jet textile printing recording apparatus according to claim 1, further comprising:
a pressure roller that presses together a transport section and the fabric, wherein
a pressing force of the pressure roller is variable.

15. The ink jet textile printing recording apparatus according to claim 1, wherein
the cleaning section has a blade member that rubs the pressure sensitive adhesive layer.

16. The ink jet textile printing recording apparatus according to claim 1, further comprising:
a drying section that dries the endless belt cleaned by the cleaning section, wherein
the drying section includes one or more selected from a water absorbing mechanism, a blowing mechanism, and a heating mechanism.

17. The ink jet textile printing recording apparatus according to claim 1, wherein
the ink composition is a colored ink composition containing a pigment.

18. The ink jet textile printing recording apparatus according to claim 1, wherein
the ink composition is a functional liquid containing organopolysiloxane as resin particles.

19. The ink jet textile printing recording apparatus according to claim 18, wherein
the ink composition is substantially free of colorants.

20. An ink jet textile printing recording method comprising:
ejecting an ink composition from an ink jet head and causing the ink composition to adhere to a fabric which is a recording medium;
placing and transporting the fabric on an endless belt; and
cleaning the endless belt, wherein
the endless belt has a pressure sensitive adhesive layer on a surface thereof,
a cleaning section includes a cleaning tank that stores a cleaning liquid,
the cleaning section includes an abrading member that rubs the pressure sensitive adhesive layer within the cleaning tank, and
the cleaning liquid contains water and a cleaning agent containing a polyoxyalkylene alkyl ether compound.
